(19) United States
(12) Patent Application Publication
(10) Pub. No.: US 2026/0289922 A1
(43) Pub. Date: Sep. 24, 2026

(54) SYSTEM

(71) Applicant: SoftBank Group Corp., Tokyo (JP)

(72) Inventor: Chiharu TACHIBANA, Tokyo (JP)

(73) Assignee: SoftBank Group Corp., Tokyo (JP)

(21) Appl. No.: 19/566,997

(22) Filed: Mar. 14, 2026

(30) Foreign Application Priority Data
Mar. 19, 2025 (JP) 2025-045148

(51) Int. Cl. G06T 19/00; G06N 3/0475; G06T 13/20; G06T 13/40; G06T 19/20; G06V 20/20

(52) U.S. Cl. CPC G06T 19/006; G06N 3/0475; G06T 13/205; G06T 13/40; G06T 19/20; G06V 20/20; G06T 2219/2004; G06V 2201/07

(57) ABSTRACT

A system includes a processor that is configured to provide a user interface through which a user sets a preferred virtual character, analyze image data captured when a portable information terminal is oriented toward a sports game venue or a sports video so as to generate an action of the virtual character, cause the virtual character to refer to a motion database of sports and obtain appropriate motion data therefrom, analyze input from the user in order for the virtual character to perform question-and-answer communication related to the sport, and generate a prompt sentence that instructs a generative AI model to generate a response, recognize an emotion of the user and, in accordance with the recognized emotion, adjust a live commentary style of the virtual character, and generate, by using the generative AI model, a response based on the prompt sentence.

### CROSS-REFERENCE TO RELATED APPLICATION

This application is based on and claims priority under 35 USC 119 from Japanese Patent Application No. 2025-045148 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional systems for presenting sports commentary and virtual characters generally provide only one-way or limited interactivity, in which a user passively receives pre-scripted commentary or fixed animations without personalized adaptation. Even when virtual characters or avatars are superimposed on sports videos, such systems typically do not dynamically analyze live or recorded sports imagery to generate appropriate character actions in real time, and do not utilize large-scale generative AI models to conduct natural question-and-answer interactions related to ongoing sports events. Furthermore, existing systems rarely recognize a user's emotional state or past preferences and therefore cannot flexibly adjust a commentary style, level of detail, or expressiveness of a virtual character in accordance with the user's current emotion and long-term behavioral tendencies. As a result, the user experience remains generic and lacks immersion, personalized engagement, and adaptive explanations aligned with individual interest in rules, tactics, or specific plays. Accordingly, there is a need for a system that enables a user to select a preferred virtual character, that analyzes sports-related image data obtained by a portable information terminal, that generates contextually appropriate actions of the virtual character by referencing a motion database including data for multiple sports, and that supports interactive question-and-answer exchanges using a generative AI model. There is also a need for such a system to recognize the user's emotion, adjust a live commentary style of the virtual character based on the recognized emotion, and further learn from user interactions and historical behavior to personalize the commentary so that it better matches the user's preferences over time.

### SUMMARY

In order to solve the foregoing problems, a system according to one aspect of the present invention comprises a processor configured to provide a user interface through which a user sets a preferred virtual character. The processor is further configured to analyze image data captured when a portable information terminal, such as a smartphone or tablet, is oriented toward a sports game venue or a sports video, and to generate actions of the virtual character based on the analysis. The processor causes the virtual character to refer to a motion database including motion data for a plurality of sports, and obtains appropriate motion data corresponding to a detected sport and event by using an index for selecting motion data for each sport, thereby realizing realistic and contextually matched character motions synchronized with the sports scene.

The processor is also configured to analyze user input received through the portable information terminal, in order for the virtual character to perform question-and-answer communication related to the sport, and to generate a prompt sentence that instructs a generative AI model to generate a response. The processor then uses the generative AI model to generate the response based on the prompt sentence, thereby enabling flexible and natural dialogue that can cover rule explanations, tactical commentary, and reactions to specific plays. Additionally, the processor recognizes an emotion of the user, for example by analyzing voice, facial expressions, or linguistic features, and adjusts a live commentary style of the virtual character, such as enthusiasm, tone, or level of detail, in accordance with the recognized emotion.

Moreover, the processor implements a learning algorithm by which the virtual character learns through interaction with the user, records past behavior and preferences of the user, and performs live commentary customized to the user's preferences on the basis of the recorded past behavior and preferences. Through repeated interactions, the system gradually refines the selection of commentary content, explanation depth, and character expressiveness for each user. As a result, the system provides an adaptive, emotionally responsive virtual character that delivers personalized sports commentary and interactive explanations in real time.

The term “system” refers to an arrangement of hardware and software components, including at least one processor and associated memory, interfaces, and programs, that cooperate to execute the functions described in the claims.

The term “processor” refers to one or more processing units, which may include a central processing unit (CPU), a graphics processing unit (GPU), a digital signal processor (DSP), a microcontroller, or any combination thereof, configured to execute instructions and perform the operations specified in the claims.

The term “user interface” refers to a hardware and software configuration, including graphical, auditory, and/or tactile elements, through which a user can input information to and receive information from the system.

The term “user” refers to a human operator who interacts with the system through the user interface and the portable information terminal.

The term “virtual character” refers to a computer-generated entity, such as an avatar, animated character, or VTuber, that can be visually presented and controlled by the system to perform actions, gestures, and speech or text output.

The term “preferred virtual character” refers to a particular virtual character selected by the user from among a plurality of available virtual characters using the user interface. The term “portable information terminal” refers to a mobile electronic device, such as a smartphone, tablet, or handheld terminal, that includes at least a display, a processor, and a camera, and that is capable of communicating with the system over a network.

The term “sports game venue” refers to a physical location where a sports event is held, such as a stadium, arena, or field, and that can be captured as image data by the portable information terminal.

The term “sports video” refers to image data representing a sports event, including live broadcasts, recorded broadcasts, streaming content, or replay footage, which can be displayed and captured by the portable information terminal.

The term “image data” refers to digital data representing still images or moving images (video frames) captured by a camera of the portable information terminal or obtained from a video source and provided to the processor for analysis.

The term “analyze image data” refers to processing image data by using one or more algorithms, such as image recognition, object detection, motion tracking, or scene understanding, to extract information relevant to sports events, player actions, ball movement, or field context.

The term “action of the virtual character” refers to a time-varying visual behavior of the virtual character, including poses, gestures, body movements, facial expressions, and lip-sync, that is generated or controlled by the processor.

The term “motion database” refers to a data storage structure that contains motion data describing predefined or parameterized actions, animations, or movement patterns for the virtual character, associated with various sports and events.

The term “motion data” refers to data representing a sequence of movements, poses, or transformations of a virtual character's body parts or skeleton, suitable for driving animation of the virtual character.

The term “plurality of sports” refers to two or more different types of sports, such as soccer, basketball, baseball, tennis, or others, for which motion data is stored in the motion database.

The term “index” refers to a data structure or mapping that associates motion data with identifiers, categories, or parameters, such as sport type, event type, or character type, enabling selection of motion data corresponding to each sport.

The term “question-and-answer communication” refers to an interactive exchange in which the user provides questions, comments, or requests, and the virtual character provides responsive information, explanations, or reactions in textual and/or spoken form.

The term “user input” refers to information received from the user through the user interface, including text input, voice input, gesture input, or other interaction signals.

The term “generative AI model” refers to a machine-learned model, such as a large language model or multi-modal generative model, configured to generate natural language text or other output in response to a prompt.

The term “prompt sentence” refers to a piece of text or structured input generated by the processor and provided to the generative AI model, the prompt sentence specifying context, instructions, or content from which the generative AI model generates a response. The term “response” refers to output generated by the generative AI model based on the prompt sentence, including at least natural language text that can be presented by the virtual character as commentary, explanation, or reaction.

The term “emotion of the user” refers to an affective state of the user, such as excitement, boredom, happiness, disappointment, or confusion, which can be inferred from user signals including facial expressions, voice tone, physiological data, or linguistic content.

The term “recognize an emotion of the user” refers to the operation of estimating or classifying the user's emotional state by analyzing one or more types of user data using rule-based or machine learning techniques.

The term “live commentary style” refers to a manner in which the virtual character presents commentary on sports events, including factors such as tone, enthusiasm level, speaking speed, vocabulary, level of analysis, and frequency of comments.

The term “adjust the live commentary style” refers to modifying one or more parameters of the virtual character's commentary behavior, such as increasing or decreasing enthusiasm, changing the amount of detail, or altering the tone, in accordance with recognized user emotion or preferences.

The term “learning algorithm” refers to a procedure or model that updates internal parameters or stored data based on user interactions, past behavior, or feedback, so that future system behavior can be adapted or improved.

The term “past behavior and preferences of the user” refers to historical data regarding the user's interactions with the system, such as questions asked, topics of interest, frequency of use, preferred detail level, and reactions to commentary, recorded by the processor over time. The term “live commentary customized to preferences of the user” refers to commentary on sports events that is generated or selected by the processor in a manner tailored to the individual user, taking into account the user's recorded past behavior, preferences, and recognized emotional state.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

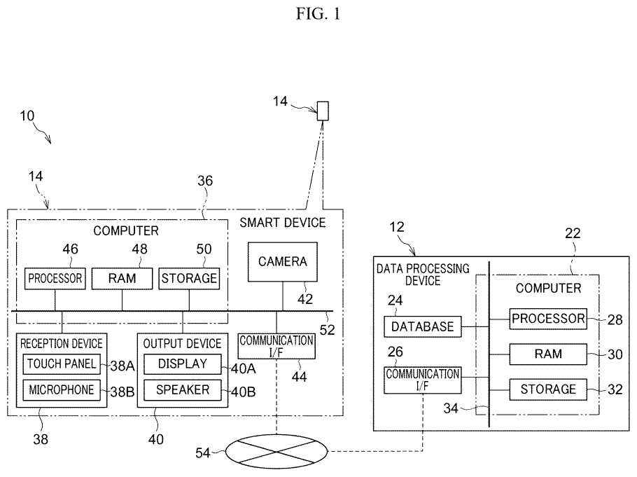

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

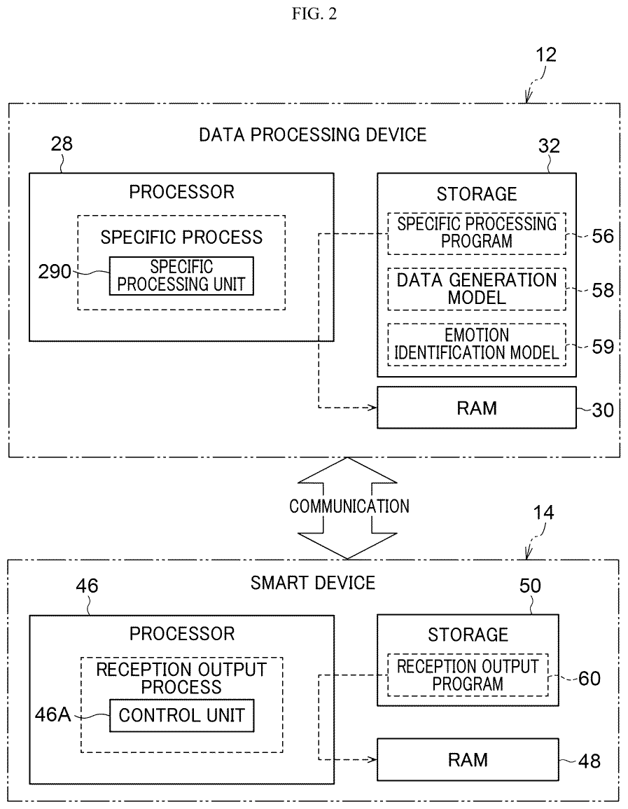

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional sports viewing systems primarily stream audiovisual content and optionally overlay static information such as scores or simple statistics. These systems do not deeply integrate real-time scene understanding, user interaction, and natural-language explanation into a unified computing architecture. As a result, they suffer from several technical limitations. First, client-side computation is often limited to basic rendering and user interface handling, without efficiently extracting structured situation information from live image data acquired by an imaging mechanism of a user terminal. Second, server-side systems typically respond to user queries with generic text or pre-authored scripts that are not tightly conditioned on fine-grained match context, user state, or the behavior of a virtual display object. Third, existing architectures do not provide a systematic way to construct prompt sentences for a generative AI model from heterogeneous runtime data such as image-derived situation information, user interaction history, and virtual character attributes. This leads to suboptimal utilization of the generative AI model and inconsistent response quality.

Furthermore, many known systems treat user emotion, user preferences, and commentary style as loosely coupled presentation parameters, rather than as first-class inputs to the computational pipeline that generates responses. This separation prevents the system from adaptively modifying commentary style, animation selection, and linguistic tone in real time based on recognized user state. Also, motion selection for virtual objects is often performed by static mapping tables or hard-coded rules, without leveraging a structured motion information storage unit indexed by competitive activity type and situation. Such approaches result in inflexible animations that are poorly synchronized with the actual progress state of the competitive activity.

From a computer technology perspective, there is a need for an improved system architecture that: (i) efficiently captures image information on a user terminal and converts it into structured situation information; (ii) uses that situation information, together with virtual object settings, to query a motion information storage unit on a server; (iii) dynamically constructs high-quality prompt sentences for a generative AI model from multiple runtime data sources; and (iv) feeds back generated response text and motion control data to the terminal in a manner that tightly couples augmented reality rendering, speech or text output, and user-adaptive behavior. Without such an integrated design, computing resources on the terminal and server are not effectively utilized, data flows remain fragmented, and the user cannot obtain a stable, context-appropriate, and interactive explanation experience.

The specific processing by the specific processing unit 290 of the data processing device 12 in Example 1 is realized by the following means.

The present invention provides a server comprising at least one processor and at least one memory storing instructions which, when executed by the at least one processor, cause the server to receive, from an information processing terminal, situation information generated on the information processing terminal by performing object recognition processing and situation recognition processing on time-series image information acquired via an imaging mechanism of the information processing terminal, the situation information indicating a progress state of a competitive activity; to search, based on the situation information and setting information of a virtual display object selected by a user on the information processing terminal, a motion information storage unit storing motion information for a plurality of types of competitive activities, and to extract motion information corresponding to the situation information; to transmit the extracted motion information to the information processing terminal for use in generating control data for posture and motion of the virtual display object and for augmented-reality superimposition on the image information; to receive, from the information processing terminal, a prompt sentence generated on the information processing terminal as descriptive text information including character information representing a question input by the user, the situation information, attribute information of the virtual display object, and optionally user characteristic information and commentary policy information based on past interaction history; to execute, using the prompt sentence as input, a response generation process by a generative AI model to generate response text information; and to transmit the response text information to the information processing terminal for presentation as utterance content of the virtual display object, including mouth-shape motion and facial-expression motion synchronized with the response text information. This enables an integrated computer-implemented pipeline in which terminal-side processing efficiently converts raw image information into structured situation information, server-side processing selects context-appropriate motion information and dynamically leverages a generative AI model via prompt sentences constructed from heterogeneous runtime data, and both sides cooperate to adapt virtual object behavior and commentary style to user state, thereby improving utilization of computing resources, response relevance, and interactivity in sports-related augmented reality systems.

The term “system” refers to an arrangement of one or more information processing devices, including at least one information processing terminal and at least one external information processing apparatus, that cooperate via a communication path to perform the functions described herein.

The term “processor” refers to a hardware computation unit, such as a central processing unit or a graphics processing unit, or a combination thereof, capable of executing instructions to perform logical, arithmetic, control, and input/output operations.

The term “information processing terminal” refers to a portable or non-portable electronic device, such as a smartphone, tablet, or other computing device, that includes at least a processor, a display, a memory, and an imaging mechanism, and that executes an application to provide user interaction and augmented reality display.

The term “external information processing apparatus” refers to a computing device or a group of computing devices, such as a server or a cloud computing system, that is located remotely from the information processing terminal and communicates with the information processing terminal via a communication path to perform at least part of data processing described herein.

The term “user interface” refers to a graphical, textual, or auditory presentation and input mechanism generated on the information processing terminal that allows a user to provide input and receive output, including selection and setting of a virtual display object. The term “virtual display object” refers to a computer-generated entity, such as a character, figure, or icon, represented in two- or three-dimensional form, which can be displayed on the information processing terminal and whose posture, motion, and expressions are controllable by data.

The term “setting information” refers to data representing one or more attributes of the virtual display object, including but not limited to an identifier, appearance parameters, commentary style, voice style, and behavioral preferences, which are stored for use in subsequent processing.

The term “storage unit” refers to any memory device, such as a semiconductor memory, magnetic storage, optical storage, or a combination thereof, configured to store data including setting information, motion information, and interaction history.

The term “imaging mechanism” refers to an image acquisition device, such as a camera or image sensor, and associated control circuitry, that captures image information of a real space or an image display surface.

The term “image information” refers to digital data representing one or more images or video frames acquired by the imaging mechanism, including pixel values, timestamps, and optionally associated metadata.

The term “real space” refers to a physical environment, such as a sports venue or a user's surroundings, that is captured by the imaging mechanism as image information.

The term “image display surface” refers to a physical surface displaying visual content, such as a display device or a projection screen on which sports video or other content is shown, and that can be captured by the imaging mechanism.

The term “object recognition processing” refers to a computational process that analyzes image information to detect and identify objects, such as players, balls, field markings, or other relevant elements, and outputs data indicating types, positions, or other attributes of the objects.

The term “situation recognition processing” refers to a computational process that interprets results of object recognition processing and other contextual data to infer a progress state of a competitive activity, such as an attack, defense, scoring event, or stoppage of play.

The term “situation information” refers to structured data indicating a progress state of a competitive activity, derived from image information through object recognition processing and situation recognition processing, and optionally including temporal, positional, and activity-type attributes.

The term “competitive activity” refers to an organized physical or virtual contest or game, such as a sport or e-sport, involving participants, rules, and a measurable outcome.

The term “communication path” refers to a wired or wireless communication medium, such as a network or communication link, that enables data transmission between the information processing terminal and the external information processing apparatus.

The term “motion information storage unit” refers to a storage unit that stores motion information associated with a plurality of types of competitive activities and competitive situations, and that can be searched based on index information or other criteria.

The term “motion information” refers to data defining posture, movement, gestures, or animation of the virtual display object, including but not limited to keyframe data, skeletal parameters, or motion control parameters.

The term “index information” refers to data used to identify, categorize, and retrieve motion information, including references to a type of competitive activity, a specific competitive situation, or other context attributes.

The term “control data for posture and motion” refers to data derived from motion information that is used by a rendering or animation engine to determine the pose, movement trajectory, and timing of the virtual display object.

The term “augmented reality display process” refers to a computational process that superimposes or composites virtual elements, including the virtual display object, onto image information of a real space or image display surface, while maintaining spatial or temporal coherence.

The term “question input” refers to information representing a query provided by a user, in textual or spoken form, concerning a competitive activity, a player, a rule, or related subject matter.

The term “character information” refers to digital data representing textual content, such as a string of characters, corresponding to the question input or other textual expressions.

The term “attribute information of the virtual display object” refers to data indicating characteristics or roles of the virtual display object, such as expertise domain, speaking style, personality traits, or visual theme.

The term “prompt sentence” refers to descriptive text information generated to serve as input to a generative AI model, the descriptive text information including at least character information representing the question input, the situation information, attribute information of the virtual display object, and optionally user characteristic information and commentary policy information.

The term “generative AI model” refers to a trained artificial intelligence model, such as a language model, configured to generate text or other content in response to a prompt sentence, by performing inference on input data.

The term “response text information” refers to textual data output by the generative AI model in response to a prompt sentence, and representing a generated answer or explanation. The term “utterance content” refers to content expressed by the virtual display object to the user, including textual display, spoken output, or a combination thereof, based on the response text information.

The term “mouth-shape motion” refers to motion control data or animation specifying positions or deformations of a virtual display object's mouth region that are synchronized with spoken or textual content to simulate speech.

The term “facial-expression motion” refers to motion control data or animation specifying expressions of a virtual display object's face, such as smiling, frowning, or emphasizing, in coordination with commentary or responses.

The term “question-and-answer presentation” refers to an interactive display process in which the virtual display object presents answers to user questions using at least visual or auditory output.

The term “voice information” refers to audio data representing sounds emitted by a user, including spoken questions or other vocal expressions, captured by a microphone or other audio input device.

The term “image information of the user” refers to image data including at least a portion of the user's body or face, captured by the imaging mechanism or another image input device.

The term “emotional state” refers to a state inferred for the user, such as excitement, boredom, confusion, or satisfaction, estimated from voice information, image information, or other user-related data.

The term “explanation style” refers to a mode of presenting information, including level of detail, degree of technicality, pacing, and use of examples, as applied to commentary or responses.

The term “writing style of the response text” refers to linguistic properties of response text information, such as formality, friendliness, conciseness, and sentence structure.

The term “interaction history” refers to recorded data representing past interactions between the user and the system, including questions asked, responses delivered, user reactions, selected virtual display objects, and viewing behavior.

The term “user characteristic information” refers to data describing traits of the user, such as experience level, interests, preferred commentary type, or language preference, derived from interaction history or explicit settings.

The term “commentary policy information” refers to data defining rules or preferences for how the system should present commentary or explanations, including emphasis on statistics, tactics, rules, or entertainment, and adapted over time based on interaction history.

In one embodiment, the system includes a terminal, a server, and a communication network connecting them. The terminal is, for example, a smartphone or tablet equipped with a processor, a memory, a display, a camera module, a microphone, a speaker, and wireless communication circuitry. The server is, for example, a rack-mount or cloud-hosted computer including one or more central processing units and one or more accelerators such as graphics processing units. The terminal executes an application running on a mobile operating system, and the server executes a server-side program running on a general-purpose operating system. The terminal stores a program in the memory. The processor of the terminal executes the program to generate a user interface on the display. The terminal causes a character selection screen to be shown. The terminal displays a list of virtual display objects, such as selectable digital characters, as graphical icons and related text. The user selects a virtual display object by touching the display. The terminal generates setting information including at least an identifier of the virtual display object, commentary style parameters, and preferred language.

The terminal stores the setting information in a local storage unit, such as a relational database or a key-value store.

The terminal uses the camera module to capture image information. The terminal controls the camera module through an imaging application programming interface and obtains image frames at a predetermined frame rate. The terminal converts the camera output into a standardized pixel format and stores current and recent frames in a circular buffer in the memory. The terminal uses an image processing library or a machine learning inference engine to perform object recognition processing on the image frames. The terminal detects objects such as athletes, balls, courts, or field lines by applying a convolutional neural network-based object detector. The object detector uses multiple feature extraction layers and detection heads to output bounding boxes and class labels. The terminal extracts positions and classes of detected objects from the output tensor and maintains object tracks across successive frames by correlating detections using motion prediction and similarity metrics. The terminal performs situation recognition processing based on the object tracks and temporal information. The terminal derives situation information indicating a progress state of a competitive activity. For example, the terminal determines whether an attack, defense, serve, penalty, or time-out is occurring by analyzing spatial relationships between objects, movement vectors, and timing data. The terminal converts the situation information into a structured representation in memory that includes at least a type of competitive activity, a current phase, numerical values such as current score or elapsed time when available, and identifiers of relevant participants.

The terminal transmits the situation information to the server via the communication network. The terminal uses a network protocol such as a secure hypertext transfer protocol to send the situation information together with the setting information of the virtual display object. The server receives and parses the situation information. The server stores motion information in a motion information storage unit. The motion information includes data structures such as skeletal animation clips, keyframe sequences, and parameterized gesture definitions. The server indexes the motion information by type of competitive activity, event type, and emotion tag. The server searches the motion information storage unit based on the situation information and the setting information of the virtual display object. The server selects motion information that matches a current event type and a commentary emphasis according to the setting information.

The server transmits selected motion information back to the terminal. The terminal receives the motion information and generates control data for posture and motion of the virtual display object. The terminal maps skeletal animation data to a rig of the virtual display object and computes a blending weight between current and next animations to avoid abrupt changes. The terminal performs an augmented reality display process. The terminal estimates a camera pose using feature point tracking and plane detection in the image frames. The terminal determines a placement position and orientation for the virtual display object in the real space. The terminal renders the virtual display object using a graphics pipeline and composites the rendered image with the camera image. As a result, the user views the virtual display object overlaid onto a live sports scene on the display.

The user provides a question input through the user interface. The user may type the question on a software keyboard or speak the question into the microphone. The terminal converts voice signals to text using a speech recognition process. The terminal stores the resulting text as character information. The terminal associates the character information with current situation information and attribute information of the virtual display object. The terminal may additionally determine user characteristic information such as an experience level and a preferred explanation detail level from interaction history. The terminal composes a prompt sentence as descriptive text information combining these elements.

For example, the terminal generates a prompt sentence such as:

“User is watching a live soccer match through an augmented reality application on a mobile device.
Sport: Soccer
Teams: Team A vs Team B
Current score: Team A 2-1 Team B
Current time: 68th minute
User level: beginner
Selected virtual character: a friendly expert analyst
User question: ‘How many goals does player number 10 have so far?’
As the selected virtual character, answer the user's question accurately based on the match
context. Respond in a concise and easy-to-understand style, suitable for a beginner viewer.”
In another example, the terminal generates a prompt sentence such as:
“The user is viewing a live basketball game with an overlaid virtual commentator.
Sport: Basketball
Score: Home 85-79 Visitor
Quarter: 4th, remaining time 3 minutes
Situation: Personal foul called on defender number 5 on a drive to the basket.
User level: intermediate
Selected virtual character: calm rules explainer
User question: ‘Why was that last play called a foul?’

Explain the rule and the referee's decision in 2-3 sentences, using clear and neutral language, and refer to the current situation where the defender made contact during a shooting motion.” The terminal transmits the prompt sentence to the server as plain text data.

The server receives the prompt sentence and executes a response generation process using a generative AI model. The server implements the generative AI model as a transformer-based neural network. The server stores model parameters including multiple self-attention layers, feed-forward layers, and embedding layers. The server converts the prompt sentence into token identifiers using a tokenizer and loads corresponding embeddings from an embedding matrix. The server processes the embeddings through stacked attention blocks. Each block computes query, key, and value vectors for each token, performs scaled dot-product attention, and aggregates context information over the entire prompt sentence. The server applies multi-head attention and positionwise feed-forward networks, with nonlinear activation functions, and adds residual connections and normalization layers.

The server uses a loss function such as a cross-entropy loss during training and updates model parameters using a gradient-based optimizer. The server may train or fine-tune the generative AI model on training data that includes domain-specific commentary and explanation examples. The server may apply data augmentation techniques such as paraphrasing, varying match situations, and randomizing numerical values to improve robustness. During inference, the server uses decoding strategies such as temperature-controlled sampling or top-k sampling to generate a sequence of output tokens while constraining length and avoiding repetition by penalizing repeated n-grams. The server forms response text information by decoding the generated tokens back into characters. The server may post-process the response text information by enforcing constraints derived from the setting information of the virtual display object, such as requiring use of a friendly tone or limiting the explanation to a small number of sentences. The server transmits the response text information to the terminal.

The terminal receives the response text information and presents it as utterance content of the virtual display object. The terminal displays the response text in a text area adjacent to the virtual display object. The terminal may convert the response text information into synthesized speech by applying a text-to-speech engine. The terminal generates mouth-shape motion and facial-expression motion synchronized with the synthesized speech. The terminal maps phoneme timing information to pre-defined facial pose data and interpolates between poses over time. The terminal thus causes the virtual display object to appear to speak the generated response to the user.

The terminal estimates an emotional state of the user from voice information or image information. The terminal may execute a separate neural network for emotion recognition. For example, the terminal extracts acoustic features from the voice signal, such as pitch, energy, and spectral coefficients, and inputs them into a recurrent or transformer-based network that outputs probabilities for several emotional categories. Alternatively or additionally, the terminal extracts facial landmarks from image information of the user and inputs landmark coordinates or appearance features into a classifier. The terminal determines a dominant emotional state and updates commentary style parameters. The terminal may send simplified emotional state information to the server. The server may adapt parameters of prompt sentence construction, such as instructing the generative AI model to be calmer or more enthusiastic, based on the emotional state.

The server records interaction history including questions, generated responses, emotional states, and selected virtual display objects in a database. The server computes user characteristic information such as a preferred level of detail and favorite types of commentary from aggregated interaction history. The server derives commentary policy information describing how to prioritize tactical analysis, statistical explanation, or rule explanations. The server transmits updated user characteristic information and commentary policy information to the terminal or stores them centrally. The terminal or the server then incorporates these parameters into subsequent prompt sentences. This configuration enables the system to alter the construction of each prompt sentence dynamically based on the accumulated interaction history, rather than using a fixed template.

In this architecture, the terminal performs computationally efficient analysis on raw image information and constructs compact situation information. The server performs more resource-intensive operations such as searching large motion information storage units and executing the generative AI model. Because the terminal transmits structured situation information instead of full frame data at all times, the system reduces communication bandwidth. The separation of image-level processing on the terminal and text-level reasoning on the server reduces end-to-end latency. The use of indexed motion information storage units allows the server to retrieve motion information with fewer database operations than naive search methods, thereby improving response time.

The server and the terminal cooperate to generate the prompt sentence and response text information following non-conventional rules that are specific to this technical field. The prompt sentence is not a simple concatenation of text, but a structured description that encodes situation information, user characteristics, and virtual display object attributes in a consistent format. By doing so, the generative AI model operates on a more informative representation than raw user questions alone. This structure leads to more accurate and stable generation of responses aligned with match context and user state. The improvement lies in the technical design of the data structures for the prompt sentence and the program logic for constructing them under resource constraints of mobile devices and real-time requirements, rather than in a mere automation of human commentary.

The system improves computer technology in several ways. The terminal optimizes the utilization of the camera and processor by performing lightweight object recognition and situation recognition locally and transmitting only derived situation information to the server when relevant changes occur. This reduces the processing load on the server and the network, improving scalability. The server processes structured situation information and user state to select motion information and construct prompt sentences more efficiently than conventional methods that would repeatedly query large context repositories or perform unstructured text retrieval. The transformer-based generative AI model receives finely conditioned prompt sentences, which reduces ambiguity and lowers the number of decoding steps needed to reach a satisfactory answer, improving computation efficiency on the hardware accelerators. The system does not merely implement a business process, but instead provides a specific technical solution to coordinating real-time imaging, motion control, and natural-language generation in a resource-constrained environment. The specific combination of data extraction from camera streams, indexed motion information retrieval, structured prompt sentence generation including situation information and emotional state data, and transformer-based inference produces a causal improvement in both responsiveness and accuracy of explanations. The reduction of unnecessary data transfer and the local pre-processing of image frames decrease latency and power consumption on the terminal. The adaptive adjustment of commentary style based on estimated emotional state and interaction history leads to a lower rate of user confusion and repeated questions, which in turn reduces average server queries per session.

In alternative embodiments, the terminal may offload more or fewer tasks to the server. In one variant, the terminal sends image information directly to the server, and the server performs both object recognition processing and situation recognition processing with a larger neural network model. In another variant, the terminal executes a reduced-size generative AI model locally for simple questions and only invokes the server-side generative AI model when complex questions or broader context are detected. In yet another variant, the motion information storage unit may be distributed between the terminal and the server, with frequently used motion information cached on the terminal and less common motion information stored on the server, thereby further reducing network round-trips. The server may also adapt the architecture of the generative AI model according to application requirements. For certain sports or competitive activities that require rapid turn-around, the server may employ a smaller number of attention layers and narrower hidden dimensions to reduce inference time while maintaining adequate quality due to the rich prompt sentence conditioning. For other applications requiring detailed analysis, the server may use a deeper model and longer context windows to capture more historical situation information. In all cases, the system maintains the fundamental architecture in which the terminal generates structured situation information and initial prompt sentence elements, and the server refines, completes, and processes the prompt sentence through the generative AI model.

Through these configurations and variations, the server, the terminal, and the interplay between them implement the invention in a manner that concretely improves the operation of the computing devices themselves in acquiring, processing, and presenting information, rather than merely automating human commentary work.

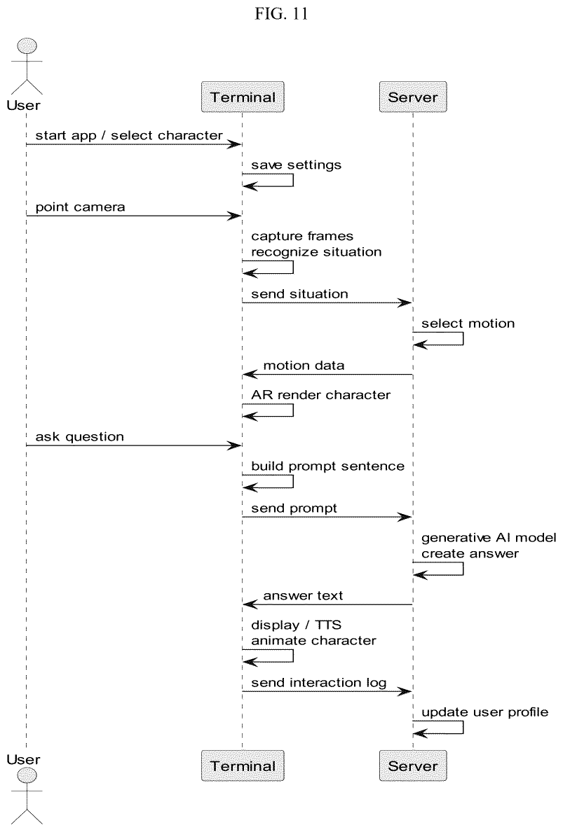

The following describes the processing flow using FIG. 11.

### Step 1:

The user starts the application on the terminal and selects a virtual display object.

As input, the terminal receives user touch operations on the display and, optionally, previously stored setting information from local storage. The terminal reads a list of available virtual display objects from a local database and renders icons and descriptions on the screen. The terminal generates new setting information including at least a virtual display object identifier, language preference, and commentary style parameters. As output, the terminal stores this setting information in a local storage unit and keeps it in working memory for later processing.

### Step 2:

The user points the terminal toward a real space or an image display surface showing a competitive activity.

As input, the terminal obtains raw sensor data from the camera module via an imaging API, including a continuous sequence of image frames and associated timestamps. The terminal converts the camera output into a normalized image format and writes successive frames into a circular buffer. As output, the terminal maintains a time-ordered buffer of image information that is ready for object recognition and situation recognition processing.

### Step 3:

The terminal performs object recognition processing on the buffered image information.

As input, the terminal uses the recent image frames stored in the circular buffer. The terminal executes a convolutional neural network on each frame, computing convolutions, activations, and pooling operations to extract feature maps, and then applies detection heads to estimate bounding boxes, class labels, and confidence scores for objects such as players, balls, field markings, and goals. The terminal filters out low-confidence detections and outputs a structured set of detection results including object classes, positions, and sizes for each frame.

### Step 4:

The terminal performs situation recognition processing based on successive detection results.

As input, the terminal uses the detection results from multiple consecutive frames and their timestamps. The terminal associates detections across frames by computing distance measures between bounding boxes and motion vectors, thereby forming object tracks. The terminal then derives high-level events by examining spatial relationships, movement directions, and velocities of the tracked objects. For example, the terminal detects an “attack,” “defense,” or “foul” situation by applying rule-based logic on distances between the ball and players, movement direction relative to goals, and sudden stops. As output, the terminal generates situation information that includes a type of competitive activity, a current phase, and event descriptors, and stores it in a structured data record.

### Step 5:

The terminal transmits situation information and setting information of the virtual display object to the server.

As input, the terminal uses the latest situation information, the setting information, and optional user identifier data. The terminal serializes these data elements into a request message using a structured text format and adds communication headers for secure transmission. The terminal sends the message over a network connection to an endpoint on the server. As output, the server receives the request and extracts the situation information and setting information for subsequent processing.

### Step 6:

The server selects motion information from a motion information storage unit based on the received data.

As input, the server uses the situation information and the setting information of the virtual display object contained in the received message. The server converts condition fields, such as competitive activity type, event type, and desired commentary emphasis, into query parameters. The server searches the motion information storage unit using indexed queries and retrieves motion records that match the parameters. The server evaluates candidate motion records by comparing tags and relevance scores and selects one or more motion records that most closely correspond to the current situation. As output, the server packages the selected motion information into a response message and sends it back to the terminal.

### Step 7:

The terminal generates control data for posture and motion of the virtual display object and performs augmented reality composition.

As input, the terminal receives the motion information from the server and uses the current camera pose and image information from the circular buffer. The terminal maps motion parameters, such as keyframe joint angles and timing data, to the skeletal rig of the virtual display object. The terminal computes interpolation between frames to ensure smooth transitions and calculates a transformation matrix to place the virtual display object at a position in the camera coordinate system. The terminal renders the virtual display object with the updated posture and motion and blends the rendered image with the live camera image.

As output, the terminal presents an augmented reality view on the display in which the virtual display object appears within or near the observed competitive activity.

### Step 8:

The user provides a question regarding the competitive activity to the virtual display object. As input, the user supplies a question either by typing text on the software keyboard or speaking into the microphone. The terminal captures raw audio samples for spoken input and runs a speech recognition algorithm that computes acoustic features and matches them to language models to convert audio into text. The terminal validates the recognized or typed text and associates it with the current situation information and interaction context. As output, the terminal stores the finalized question as character information for use in prompt sentence generation.

### Step 9:

The terminal constructs a prompt sentence combining the user question and contextual data. As input, the terminal uses the character information representing the user question, the latest situation information, the setting information of the virtual display object, and user characteristic information and commentary policy information obtained from prior interactions. The terminal merges these elements according to a prompt template and concatenates them into a structured text description. During this data processing, the terminal inserts explicit labels for items such as sport type, score, time, user level, and desired explanation style, thereby converting internal data structures into a human-readable but machine-interpretable prompt sentence. As output, the terminal generates a complete prompt sentence, for example:

“User is watching a live soccer match through an augmented reality application on a mobile device.
Sport: Soccer
Teams: Team A vs Team B
Current score: Team A 2-1 Team B
Current time: 68th minute
User level: beginner
Selected virtual character: a friendly expert analyst
User question: ‘How many goals does player number 10 have so far?’

As the selected virtual character, answer the user's question accurately based on the match context. Respond in a concise and easy-to-understand style, suitable for a beginner viewer.”

The terminal outputs this prompt sentence as text data prepared for transmission.

### Step 10:

The terminal transmits the prompt sentence to the server for processing by the generative AI model.

As input, the terminal takes the generated prompt sentence and necessary identifiers such as a session ID. The terminal wraps the prompt sentence into a request message, adds metadata specifying desired response length and language, and sends the message over the network to the server. As output, the server receives the request containing the prompt sentence.

### Step 11:

The server executes a response generation process by the generative AI model using the prompt sentence.

As input, the server uses the prompt sentence text received from the terminal. The server tokenizes the prompt sentence, converting the text into a sequence of token IDs, and loads corresponding embedding vectors. The server processes the embeddings through the layers of the transformer-based generative AI model, performing matrix multiplications, attention weight calculations, and nonlinear transformations to produce hidden representations. The server then generates response tokens step by step, at each step computing probabilities for possible next tokens based on the hidden state and sampling or selecting a token according to predefined decoding parameters. As output, the server obtains a sequence of token IDs representing the generated answer and decodes them into response text information.

### Step 12:

The server post-processes the response text information and transmits it to the terminal. As input, the server takes the raw generated response text information. The server applies formatting rules that enforce a maximum number of sentences and consistency with the selected commentary style, and removes unwanted or irrelevant content. The server may insert the name or role description of the virtual display object into the initial part of the response. The server then encapsulates the cleaned response text information into a response message with appropriate headers. As output, the server sends the response message containing the response text information to the terminal over the communication network.

### Step 13:

The terminal presents the response as utterance content of the virtual display object.

As input, the terminal receives the response text information from the server and uses the current rendering state of the virtual display object. The terminal displays the response text in a dialogue area adjacent to the virtual display object and optionally invokes a text-to-speech engine to synthesize audio from the response text. The terminal analyzes the synthesized audio or phoneme sequence to compute timing for mouth-shape changes and facial expressions and applies these to the animation system controlling the virtual display object.

As output, the terminal outputs synchronized audio through the speaker and visual animation on the display, resulting in the virtual display object appearing to speak the generated response to the user.

### Step 14:

The terminal estimates the user's emotional state and adapts commentary style parameters.

As input, the terminal uses recent voice information from the microphone and image information of the user captured by the camera, together with the current interaction context. The terminal extracts acoustic features and facial expression features and applies a trained classifier that calculates probability scores for several emotional categories. The terminal selects the most likely emotional state and updates local commentary style parameters such as tone intensity, explanation speed, and level of detail. The terminal records the emotional state and associated interaction data into an interaction log. As output, the terminal provides updated style parameters for future prompt sentence construction and motion selection.

### Step 15:

The server accumulates interaction history and updates user characteristic information and commentary policy information.

As input, the server receives logs or periodic summaries from the terminal, including past questions, response usage, estimated emotional states, and selected virtual display objects. The server stores this data in a user profile storage and applies aggregation algorithms, such as statistical counting or clustering, to infer user preferences and behavior patterns. The server then adjusts user characteristic information, such as preferred explanation depth or favored topics, and updates commentary policy information that specifies how to instruct the generative AI model in future prompt sentences. As output, the server saves the updated user characteristic information and commentary policy information and makes them available for incorporation into subsequent prompt sentences exchanged with the terminal.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional systems for presenting live sports commentary on a user device typically rely on fixed, preauthored commentary streams or simple rule-based overlays that are not able to adapt in real time to rich audiovisual context, user-specific preferences, or the user's current emotional state. As a result, such systems often provide generic information that does not fully exploit available computational resources, such as generative AI models and on-device sensors, and do not achieve technical optimization in terms of how multimedia data and natural language responses are generated, selected, and rendered.

In particular, existing approaches generally treat live video processing, database access, and commentary generation as loosely coupled components, which leads to technical inefficiencies. For example, video analysis may be performed independently of commentary generation, requiring multiple redundant passes over the same data. Likewise, user interaction (such as questions asked during a match) is often handled in a separate dialog system that does not share context, leading to repeated context reconstruction and additional processing overhead. These fragmented pipelines increase latency, network traffic, and processor load, and reduce the responsiveness and consistency of the interactive experience.

Furthermore, typical systems that attempt to incorporate learning or personalization often operate at a coarse granularity, such as recommending content but not dynamically controlling how a generative AI model is prompted at runtime. Such systems do not maintain a unified representation of user preferences, historical behavior, and current emotional state, and thus cannot systematically adjust the style and content of generated commentary and responses in a fine-grained manner. This limitation leads to suboptimal utilization of the generative AI model and prevents effective adaptation of prompts and outputs based on real-time conditions.

Additionally, systems that overlay text on live video frequently perform rendering as a simple, separate layer without coordinating it with upstream recognition and generation stages. This can cause synchronization issues, redundant re-rendering, and inefficient use of graphics processing resources, particularly when commentary must be updated at high frequency according to detected events. As generative AI models are integrated into these workflows, naive designs may repeatedly send large context payloads and unstructured instructions, resulting in unnecessary computation and communication overhead. Accordingly, there is a need for a computer-implemented system that technically improves the way live video, structured sports data, user interaction, and generative AI models are orchestrated. Such a system should (i) integrate event recognition, context retrieval, prompt construction, and generation into a single coordinated pipeline, (ii) exploit user history and emotional state to adjust prompts and outputs automatically, and (iii) manage overlay rendering in a manner that reduces latency and resource consumption while maintaining tight synchronization with recognized events. By doing so, the system can improve the operation of the underlying computer technology itself, including more efficient use of processing, storage, and network resources and more effective control of a generative AI model through structured prompt sentences.

The specific processing by the specific processing unit 290 of the data processing device 12 in Application Example 1 is realized by the following means.

The present invention provides a server comprising a processor configured to acquire, from a user apparatus, setting information of a virtual entity selected and configured by a user and image information captured by an imaging device, analyze the image information by using image-processing computational resources and trained recognition computational resources so as to recognize a competitive event and obtain competitive context information, select corresponding action information from an action storage unit including action information relating to a plurality of types of competitive activities and index information for specifying the action information, and generate a structured prompt sentence based on the setting information of the virtual entity, the competitive context information, and the action information, the structured prompt sentence instructing a generative information-processing resource to generate commentary information and response information; to input the prompt sentence into a generative AI model serving as the generative information-processing resource, receive, from the generative AI model, natural language information including the commentary information and the response information, and perform postprocessing on the received natural language information; to acquire voice input or character input from the user, analyze the input for incorporation into an updated prompt sentence, and estimate an emotional state of the user by using emotional-estimation computational resources; to adjust a style and an expression mode of the commentary information and the response information based on the estimated emotional state, the setting information of the virtual entity, and history information including past input history, viewing history, and virtual-entity selection history recorded in a history storage unit by using learning computational resources, thereby updating conditions for generating the commentary information and the response information; and to cause the user apparatus to synthesize and present the commentary information and the response information overlaid on the image information by using display computational resources. This enables an integrated, technically improved processing pipeline in which event recognition, context retrieval, prompt construction, generative AI inference, adaptive style control, and video overlay rendering are coordinated on the basis of structured prompt sentences and learned user-specific parameters, thereby reducing redundant computation and communication, improving latency and synchronization between live video and generated outputs, and enhancing the efficiency and effectiveness of the underlying computer system in generating and presenting context-aware commentary and interactive responses.

The term “user apparatus” refers to an information processing device, such as a mobile communication terminal, tablet terminal, or other computing device including at least a display, an input interface, a communication interface, and a processor, which is operated by a user to view images, provide inputs, and present outputs generated by the system. The term “user interface” refers to a display screen and associated input controls presented on the user apparatus, through which a user can view information and provide selections, configurations, and other inputs to the system.

The term “information presenting unit” refers to a functional component implemented by hardware and software of the user apparatus that outputs visual or auditory information, including menus, lists, and setting screens, to the user via a display or speaker.

The term “information acquiring unit” refers to a functional component implemented by hardware and software of the user apparatus that receives user inputs, including touch operations, key operations, and voice inputs, and transfers the acquired input information to the processor of the system.

The term “virtual entity” refers to a computer-generated character, agent, or persona represented by digital data, which is associated with attributes such as appearance, voice characteristics, language preference, and commentary style, and which is used to present commentary and responses to the user.

The term “attributes of a virtual entity” refers to parameters defining characteristics of the virtual entity, including but not limited to personality traits, emotional tone, speaking style, and visual representation, which control how the virtual entity behaves and communicates.

The term “speaker characteristics” refers to parameters that define how the virtual entity speaks, including intonation, level of excitement, speaking speed, politeness degree, and linguistic style.

The term “language of a virtual entity” refers to the natural language or combination of natural languages in which the virtual entity outputs commentary information and response information to the user.

The term “imaging device” refers to an image-capturing component such as a camera module of the user apparatus or an external camera, which acquires image information representing a real-world competitive activity scene or a video displayed on a screen.

The term “image information” refers to digital data representing still images or moving images acquired by the imaging device or obtained from a prerecorded or streamed video source, including pixel data, frame sequences, and associated metadata such as timestamps. The term “competitive activity” refers to an organized physical or electronic activity, such as a sport or game, in which participants compete according to predefined rules, and which can be represented by image information and associated event data.

The term “competitive event” refers to a specific occurrence within a competitive activity, such as a scoring play, foul, penalty, turn change, or other rule-defined situation, which can be detected or inferred from image information and contextual data.

The term “competitive context information” refers to structured data describing a state of the competitive activity at or around a competitive event, including information such as teams or participants, scores, elapsed time, identified events, and related statistical information.

The term “image-processing computational resources” refers to hardware and software resources, including central processing units, graphics processing units, and image-processing libraries or algorithms, that are used to perform operations such as filtering, resizing, feature extraction, and object detection on image information.

The term “trained recognition computational resources” refers to hardware and software resources, including trained machine learning models and associated inference engines, that are used to classify, detect, or recognize competitive events or other features from image information.

The term “action storage unit” refers to a storage resource, such as a memory device or database, that stores action information related to a plurality of types of competitive activities, along with index information used to retrieve specific action information.

The term “action information” refers to structured data representing motions, actions, or patterns associated with competitive activities, including, for example, motion types, typical sequences of events, and commentary-relevant descriptors.

The term “index information” refers to data used as keys, identifiers, or indices to select and retrieve action information from the action storage unit, based on parameters such as type of competitive activity, event type, or temporal position.

The term “setting information of a virtual entity” refers to configuration data that define how a virtual entity should operate in a particular session, including selected attributes, speaker characteristics, language, and other behavior-controlling parameters chosen by the user. The term “prompt sentence” refers to structured input information, typically in natural language or a structured text format, that is provided to a generative AI model to instruct the model regarding a generation task, including required content, style, and constraints. The term “generative information-processing resource” refers to a computational resource, such as a server-side or cloud-based generative model execution environment, that receives a prompt sentence and outputs generated information based on learned parameters.

The term “generative AI model” refers to a machine learning model, such as a large language model, that generates natural language or other content in response to a prompt sentence, and that is trained on large-scale data to predict next tokens or structures.

The term “commentary information” refers to natural language output generated by the generative AI model or other processing, describing or narrating competitive events and competitive context information in real time or near real time.

The term “response information” refers to natural language output generated by the generative AI model or other processing that answers questions or addresses inputs provided by the user, based on competitive context information and other data.

The term “natural language information” refers to text or speech data expressed in a human language and generated or processed by the system, including commentary information and response information output to the user.

The term “voice input” refers to audio data representing spoken utterances by the user, captured by a microphone and optionally converted into textual data by a speech recognition process.

The term “character input” refers to input data provided by the user via a text entry interface, such as a keyboard or touchscreen, including questions, commands, or configuration texts. The term “emotional-estimation computational resources” refers to hardware and software components, including models, algorithms, and inference engines, that analyze user-related data such as voice features, textual expressions, or interaction patterns, in order to estimate an emotional state of the user.

The term “emotional state of the user” refers to an estimated mental or affective condition of the user, such as excitement, boredom, happiness, or frustration, inferred by the system from one or more types of user-related data.

The term “style of the commentary information and the response information” refers to characteristics of expression in the generated natural language information, including tone, formality level, sentence length, degree of excitement, and presence or absence of humor or technical detail.

The term “expression mode” refers to parameters defining how content is expressed, including choice of vocabulary, structural patterns, use of first or third person, and timing or frequency of output.

The term “display computational resources” refers to hardware and software resources responsible for rendering and displaying information on the user apparatus, including graphics processing units, display drivers, and rendering libraries or frameworks. The term “overlay and display” refers to a process in which generated natural language information, such as commentary information and response information, is rendered on top of or in association with image information so that both image information and generated information are simultaneously visible on a display.

The term “history storage unit” refers to a storage resource, such as a memory device or database, that stores history information related to the user, including past inputs, viewing records, and virtual-entity selections.

The term “past input history” refers to records of previous user inputs, including questions, commands, and configuration operations, which are stored and used by the system for adaptation and learning.

The term “viewing history” refers to records of competitive activities and content that the user has previously viewed, including types of competitive activities, duration, and timing. The term “virtual-entity selection history” refers to records of which virtual entities and corresponding settings have been selected or customized by the user in past sessions. The term “learning computational resources” refers to hardware and software resources, including machine learning training or adaptation modules, that update parameters, rules, or control data used for generating commentary information and response information, based on history information or other data.

The term “generation conditions of the commentary information” refers to parameters and constraints used during generation of commentary information, including desired style, length, focus points, and prioritization of certain types of context, which can be updated by learning computational resources.

The term “server” refers to one or more computing devices, including at least one processor, storage device, and communication interface, that execute programs to perform the functions attributed to the processor in the claims and specification.

In one embodiment, a server cooperates with a terminal operated by a user to implement the claimed system. The server includes at least one hardware processor, a main memory, a non-transitory storage device, and a network interface. The terminal includes a display, a touchscreen or equivalent input interface, a microphone, a camera as an imaging device, one or more hardware processors, and a wireless communication interface. The server and the terminal communicate over a packet-based network such as a cellular network or a wireless local network.

The terminal executes an application program stored in a non-transitory memory. The terminal uses an operating system such as a mobile operating system and uses software libraries such as a camera control library, an audio input library, and a rendering library. In one example implementation, the terminal uses a camera framework (for example, a camera control framework in a mobile operating system), an audio interface for microphone capture, and a graphics rendering interface (for example, a 2D canvas API or a low-level graphics API such as a shader-based drawing interface) to display overlays.

The server executes server-side software on a server operating system. The server uses a web framework, a database management system, and a runtime library for a generative AI model. In one example, the server uses a relational database engine to implement an action storage unit and a history storage unit. The server uses a numerical computation library for image-processing computational resources and trained recognition computational resources. The server uses a deep learning framework such as a tensor computation library to execute an event recognition model and a generative AI model.

The terminal provides a user interface to the user. The terminal displays, on the display, a list of virtual entities together with selectable attributes such as personality type, level of excitement, and language. The terminal renders this list using user interface components provided by the operating system. The user touches the display to select a virtual entity and to adjust attributes. The terminal records the selected attributes as setting information of the virtual entity in a structured format with fields including an identifier of the virtual entity, a style identifier, an emotional tone parameter, and a language parameter. The terminal stores this setting information in a local storage area and transmits the setting information to the server through the network interface using a structured request.

The server receives the setting information from the terminal and stores the setting information in the history storage unit, which is implemented as tables or collections in the database. The server associates the setting information with a user identifier. The server later uses this stored setting information to control generation conditions of commentary information and response information.

The terminal acquires image information of a competitive activity. The terminal uses the camera to capture frames representing a real-world sports event or a reproduced video. The terminal converts the sensor output of the camera to digital frame data in a color space such as YUV or RGB and stores the frame data in a frame buffer. The terminal may compress the frame data or extract downsampled frames to reduce transmission bandwidth. The terminal transmits the image information or derived features to the server via the network interface. The server receives the image information and temporarily stores it in a memory buffer. The server uses image-processing computational resources, such as a software library for matrix and vector operations, to perform pre-processing including resizing, normalization of pixel values, and color space conversion. The server then applies trained recognition computational resources to the pre-processed frames. In one embodiment, the server uses a convolutional neural network or a hybrid convolutional and recurrent neural network trained to classify sequences of frames into event categories such as “goal,” “foul,” “corner,” “free kick,” “timeout,” or “no event.”

The server uses specific features as inputs to the event recognition model. For example, the server derives feature tensors representing spatial-temporal patches of the image information, extracts keypoints of players and a ball using a pose estimation sub-network, and concatenates these features. The event recognition network outputs, for each time window, probability values for event categories. The server applies a threshold and a temporal smoothing algorithm to these probability values to decide that a competitive event has occurred and to select a single event label with high confidence. This arrangement reduces false positives and stabilizes event detection when the image information is noisy or partially occluded.

The server generates competitive context information based on the recognized event label and timing. The server queries the action storage unit and, in some embodiments, an external sports data store. The server uses index information in the action storage unit to locate action information. The server maps the event label and a sport-type identifier to an index key. The server executes a database query that selects action information records whose index fields match the index key. The selected action information may include structured fields describing a motion type, typical verbal descriptions, and tactical significance. The server compiles these fields together with temporal data, score, participant identifiers, and other statistics into competitive context information.

The server generates a prompt sentence for a generative AI model. The server constructs the prompt sentence as text that includes system-level instructions, a representation of the virtual entity, a description of the competitive context, and a task specification for commentary or question answering. The server uses string-building operations to join pieces such as: “You are a virtual sports commentator. You speak in excited but clear language. A player has just scored a goal from outside the penalty area. Generate one or two short sentences of live commentary in English, mentioning the scorer and the updated score.”

The server may add information about the user's preferences and emotional state, as described below. The server then sends this prompt sentence to the generative AI model as input.

The server implements the generative AI model using a generative information-processing resource. In one embodiment, the server hosts a transformer-based large language model. The model comprises multiple transformer layers, each including multi-head self-attention, feed-forward sub-layers, and layer normalization. The model is parameterized by weight matrices and bias vectors learned from large-scale text data. During inference, the server tokenizes the prompt sentence into numerical token identifiers, embeds the tokens into continuous vectors, and propagates the vectors through the transformer layers. The model uses attention mechanisms to condition each output token on all previous tokens, including those representing the virtual entity attributes and the competitive context.

The server defines generation parameters such as maximum token count, sampling temperature, and top-k or top-p thresholds. The server selects these parameters to limit latency and to control variation in generated outputs. The server receives a sequence of output tokens from the generative AI model and decodes the tokens into natural language text. The server then performs post-processing to remove undesired control sequences, to trim length, and to match the expected character encoding.

The terminal acquires voice input or character input representing user questions. The terminal uses the microphone and an audio input library to record an audio signal. The terminal applies a speech recognition module to convert the audio signal to textual characters. The speech recognition module may be an on-device or network-based model using acoustic and language models to map phonetic features to words. Alternatively, the user directly enters text using the touchscreen keyboard. The terminal packages the recognized text as character input and transmits the input together with a timestamp and session identifier to the server. The server receives the user input and stores it in the history storage unit. The server analyzes the text input by applying natural language processing steps such as tokenization, part-of-speech tagging, and intent detection. The server determines whether the user input contains a question about rules, tactics, or a specific event. The server optionally extracts entities such as player names or event types. The server then includes the processed user input as part of an updated prompt sentence. For example, the server may construct a prompt sentence such as: “You are a friendly virtual sports commentator. Context: A player has just received a yellow card for a late tackle. User question: ‘Why did the referee give a yellow card?’ Explain the reason in one or two short sentences, in simple English.”

The server also estimates an emotional state of the user based on the user's inputs and behavior. The server uses emotional-estimation computational resources. For voice input, the server may compute acoustic features such as pitch, energy, and spectral shape, and apply a trained classifier (for example, a neural network with recurrent units or a transformer encoder) to assign probabilities to emotional categories such as “excited,” “bored,” or “frustrated.” For character input, the server may use a text-based emotion classifier that analyzes word choice and punctuation. The server combines these estimates using a fusion algorithm, such as a weighted average of probabilities, to derive an overall emotional state estimate.

The server uses the estimated emotional state to adjust the style and expression mode of commentary information and response information. The server maps each emotional state to parameters such as sentence length, degree of excitement, and use of technical terms. The server injects these parameters into the prompt sentence. For example, if the emotional state is “bored,” the server adds instructions such as “Use more energetic and engaging language” to the prompt sentence. If the emotional state is “frustrated,” the server adds instructions such as “Explain calmly and clearly and avoid excessive excitement.” This dynamic modification of the prompt sentence alters the token distribution at the input of the generative AI model, which changes the generated output in a controlled manner.

The server records past input history, viewing history, and virtual-entity selection history in the history storage unit. The server associates each record with metadata, including timestamps and identifiers of content and settings. The server uses learning computational resources to update generation conditions based on this history. In one embodiment, the server trains a recommendation model or a small auxiliary neural network that maps history features to preferred style parameters and content focus parameters. The server computes features such as frequency of certain question types, typical session duration, and recurrent selection of certain virtual entity attributes. The server then adjusts prompt sentence construction rules, such as weighting of tactical explanations versus emotional reactions, according to the learned mapping.

The generative AI model is initially trained offline using a supervised learning method. The server trains the model on a large corpus of text, including examples of sports commentary, explanations of rules, and dialog-style question-answer pairs. The server uses a loss function such as cross-entropy between the predicted token distribution and the ground truth next token, and updates the model weights by backpropagation and stochastic gradient descent or a variant such as Adam. The server may perform further fine-tuning on a more focused dataset including structured prompt sentences that embed context and style instructions. During fine-tuning, the server may apply data augmentation techniques such as paraphrase generation and context shuffling to improve robustness. This training procedure results in a generative AI model that is sensitive to prompt structure and capable of producing coherent commentary and answers with specified styles.

The server coordinates the generative AI model with the event recognition model and the prompt sentence construction logic to form an integrated pipeline. The server avoids re-sending full historical context and user preferences with every prompt. Instead, the server stores compact state vectors or profile parameters derived from the history storage unit and emotional-estimation computational resources. The server then encodes these parameters as short textual or token-based hints in the prompt sentence. This architecture reduces the size of data transmitted to the generative AI model and thus reduces computation cost and latency. As a result, the server improves throughput and responsiveness when generating commentary for high frame-rate competitive activities.

The terminal receives commentary information and response information in natural language and overlays this information on the image information. The terminal uses display computational resources, such as a graphics processing unit and a rendering API, to compose the overlay. The terminal draws semi-transparent background shapes and renders text with anti-aliasing. The terminal uses a timing mechanism to align the display of commentary information with the corresponding competitive event time range. The terminal maintains a buffer of commentary items and schedules their appearance and disappearance on the display.

By tightly synchronizing overlay timing with event recognition results produced by the server, the terminal avoids stale or misaligned commentary that would otherwise confuse the user.

The integrated design produces technical effects beyond simple automation of human commentary. The server reduces redundant accesses to image information by performing event recognition once and by supplying a concise, structured representation of competitive context to the generative AI model. The server minimizes repeated context reconstruction for user questions by maintaining persistent state in the history storage unit and by embedding only incremental context changes in prompt sentences. The server and the terminal together reduce communication load by transmitting compact identifiers and parameters instead of full raw data whenever possible. These optimizations lead to lower end-to-end latency for commentary generation and lower network bandwidth usage.

The system improves accuracy and consistency of event-related commentary compared with a system that simply applies a generic generative AI model to unstructured user input.

Because the server derives competitive context information from an event recognition network and an action storage unit with explicit index information, the generated commentary is grounded in structured data describing the current state of the competitive activity. This grounding decreases the frequency of factually incorrect statements produced by the generative AI model. The server's combination of action information and contextual statistics provides the generative AI model with features that are not readily observable from the video frames alone, such as cumulative score and player-specific statistics. The system also improves computational efficiency of rendering on the terminal. By generating commentary in a form that explicitly references timing information and event identifiers, the terminal can manage overlay lifetimes deterministically instead of re-rendering full-text overlays every frame. The terminal updates only overlays whose associated time windows become active or expire. This reduces draw calls and memory bandwidth usage on the graphics processing unit.

The server uses particular rules and non-conventional procedures to determine how prompt sentences are constructed and updated. For instance, the server enforces a rule that competitive context information is always summarized as a small set of key-value statements before being embedded into the prompt sentence. The server also enforces an order in which segments appear in the prompt sentence: system instruction, virtual entity description, competitive context description, user question (if present), and style adjustment directives derived from emotional state and history. This enforced structure is tuned to exploit the attention mechanisms of the generative AI model, leading to more stable and predictable generation behavior. Such structured prompting and dynamic modification of prompts based on machine-estimated emotional state and historical interactions represent a procedure that differs substantially from typical manual prompt construction by humans.

The server may employ alternative architectures in other embodiments. For image analysis, the server may use a transformer-based vision model or a three-dimensional convolutional neural network to process sequences of frames. For emotional state estimation, the server may apply a multimodal fusion model that uses both textual and audio features in a shared latent space. For learning from the history storage unit, the server may use reinforcement learning techniques in which the system observes implicit feedback such as whether the user continues to view the commentary, changes the virtual entity, or asks follow-up questions, and adjusts generation parameters to maximize engagement metrics. These alternative architectures remain within the scope of the invention because they rely on the same principle of integrated event recognition, structured prompt construction, generative AI model control, and overlay rendering.

The terminal may also vary in configuration. In some embodiments, the terminal performs part of the image-processing computational tasks locally, for example by running a lightweight event recognition model to pre-filter frames. The terminal may extract region-of-interest features and send only those features to the server, thereby further reducing communication load. In other embodiments, the terminal may render an animated visual representation of the virtual entity that lip-syncs to synthesized speech generated from commentary information. The terminal may use a text-to-speech engine and blend phoneme timing information with animation keyframes, thus extending the overlay to animated avatars while still using the same upstream data flow from the server.

The system as a whole, therefore, provides a concrete implementation in which the server and the terminal cooperate to process image information, structured action information, user inputs, and history data to compute competitive context information, construct structured prompt sentences, execute a transformer-based generative AI model, and overlay context-aware commentary and interactive responses on live images. The described hardware and software modules, data structures, and algorithmic flows demonstrate that the invention is not limited to an abstract idea, but rather implements specific improvements in computer technology, including reduction in computation and communication overhead, improved accuracy and synchronization of generated outputs, and an adaptive control mechanism over a generative AI model that is not achievable by manual human commentary alone.

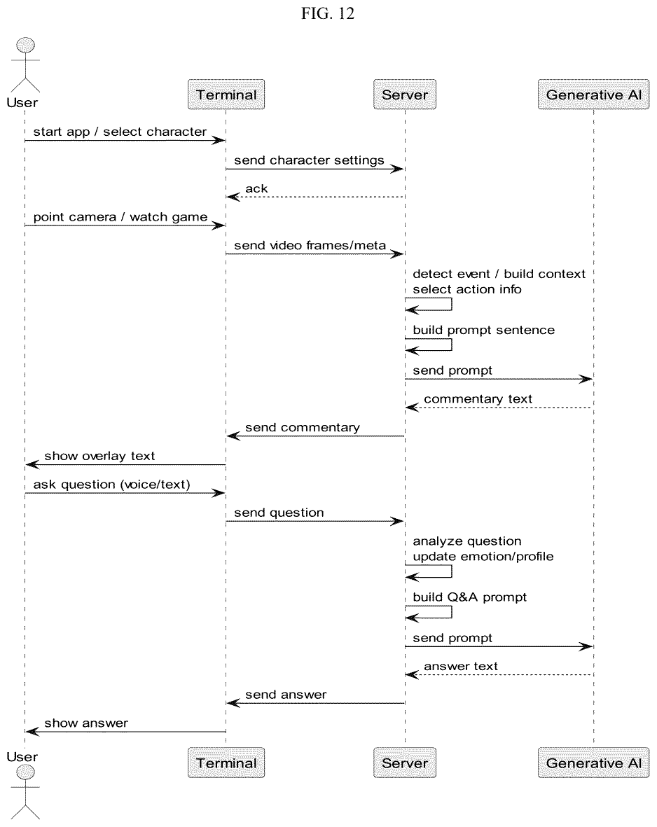

The following describes the processing flow using FIG. 12.

### Step 1:

The user activates the application on the terminal and selects a virtual entity. The terminal displays, as input to this step, a list of virtual entity options and associated attribute settings (style, tone, language) retrieved from local storage or previously cached data. The terminal receives as user input touch operations on the display that specify a particular virtual entity and its attributes. The terminal processes these inputs by mapping UI selections to internal identifiers and parameters, thereby generating, as output, a virtual entity setting record that includes a virtual entity ID, style parameters, and language parameters.

### Step 2:

The terminal transmits the virtual entity setting record to the server.

The terminal uses, as input, the virtual entity setting record produced in Step 1. The terminal packages this record into a structured request including a user identifier and session identifier. The terminal performs data serialization and network communication processing, and outputs a network message sent via a communication interface to the server.

### Step 3:

The server receives and stores the virtual entity setting record.

The server takes, as input, the network message received from the terminal containing the virtual entity setting record. The server parses the message using a communication protocol stack, extracts the virtual entity ID and associated parameters, and performs a database insert or update operation into a user profile table. As output, the server produces a stored profile entry indexed by the user identifier and session identifier, which will be referenced in subsequent processing.

### Step 4:

The terminal captures image information of a competitive activity.

The terminal uses, as input, sensor signals from the imaging device (camera) when the user points the terminal toward a sports field or a playback screen. The terminal converts analog or raw sensor data into digital image frames using camera driver circuitry and a camera control library, and performs basic color space conversion and formatting. The terminal outputs a sequence of digital frames, each tagged with a timestamp and frame index, into a frame buffer held in terminal memory.

### Step 5:

The terminal preprocesses and transmits image information to the server.

The terminal uses, as input, the sequence of digital frames generated in Step 4. The terminal may downsample the frames, compress them (for example, to JPEG), or extract feature summaries such as frame histograms or keypoint descriptors. This involves pixel-wise operations and block-wise averaging to reduce resolution and data size. The terminal outputs compressed frames or feature packets together with metadata, and transmits them to the server as network packets.

### Step 6:

The server receives image information and performs image preprocessing.

The server uses, as input, the compressed frames or feature packets received from the terminal. The server decodes compressed images and stores them in server memory, then applies image-processing operations such as resizing to a fixed network input size, normalizing pixel intensity values, and channel reordering. These operations are applied in a vectorized manner using image-processing computational resources. The server outputs preprocessed frame tensors suitable as input to an event recognition model.

### Step 7:

The server detects competitive events using a trained recognition model.

The server takes, as input, the preprocessed frame tensors from Step 6 and, in some embodiments, historical frame context from previous time windows. The server feeds these tensors into a trained event recognition neural network, such as a convolutional network or a temporal convolutional network, which performs convolution, pooling, and activation operations to obtain feature maps. The server then applies a classification layer that computes probability values for each event class. By comparing these probabilities against thresholds and applying temporal smoothing over consecutive frames, the server outputs an event detection result including an event type label (for example, “goal” or “foul”), a confidence score, and a corresponding event time.

### Step 8:

The server generates competitive context information.

The server uses, as input, the event detection result from Step 7 and a current session identifier. The server queries an action storage unit and additional sports data tables by issuing structured queries with parameters such as sport type, event type, and event time. The server retrieves records describing the teams or participants, current score, involved players, and standard motion descriptions associated with the event type. The server fuses these retrieved fields into a single competitive context object, performing data joins and field normalization. As output, the server produces structured competitive context information that encapsulates the recognized event and its surrounding state.

### Step 9:

The server selects action information from the action storage unit.

The server takes, as input, the competitive context information and index information stored in the action storage unit. The server derives an index key from the event type, sport identifier, and situational attributes (for example, field position or game phase), and executes a lookup operation or indexed query on the action storage unit. The action storage unit returns candidate action information records. The server applies selection criteria, such as matching priority flags or similarity scores, to choose the most appropriate action information. The server outputs selected action information including motion type labels, template descriptions, and other commentary-relevant data.

### Step 10:

The server retrieves user profile and history information.

The server uses, as input, the user identifier for the current session. The server queries the history storage unit for entries that include past input history, viewing history, and virtual entity selection history. The server aggregates and processes these entries by computing statistics such as frequent question topics, commonly selected entity styles, and average session duration. The server then condenses these statistics into profile parameters, such as preferred explanation depth and favored commentary tone. The server outputs a user profile vector or parameter set that summarizes historical behavior.

### Step 11:

The server estimates the user's emotional state.

The server takes, as input, signals relating to user behavior, such as recent voice input, textual input, and interaction timing data received from the terminal. For voice input, the server computes acoustic features (pitch, energy, spectral coefficients) by performing short-time Fourier transforms and statistical aggregation over frames. For text input, the server tokenizes the text and extracts features such as sentiment scores and presence of exclamation marks. The server feeds these features into an emotion classification model, such as a neural network that outputs probabilities for emotional categories. By selecting the category with the highest probability, the server outputs an estimated emotional state and, in some cases, a confidence value.

### Step 12:

The server constructs a prompt sentence for the generative AI model.

The server uses, as input, the competitive context information from Step 8, the selected action information from Step 9, the virtual entity setting record from Step 3, the user profile parameters from Step 10, and the estimated emotional state from Step 11. The server applies deterministic rules to assemble these elements into a structured text string. The server generates segments such as a system instruction, a virtual entity description, a context description, and style directives. For example, the server may produce:

“You are a virtual sports commentator with an excited but clear speaking style. Context: Team A just scored a goal from outside the penalty area, making the score 2-1. The user prefers brief, energetic explanations. The user currently seems bored, so increase excitement. Generate one or two short sentences of live commentary in English mentioning the scorer and the new score.”

The server concatenates these segments with delimiters and line breaks as needed. The server outputs this final prompt sentence as a text input ready for the generative AI model.

### Step 13:

The server performs natural language generation with the generative AI model.

The server uses, as input, the prompt sentence from Step 12. The server tokenizes the prompt into token indices, embeds the indices into vectors, and passes the vectors through a transformer-based generative AI model layer by layer. Each layer performs matrix multiplications for self-attention and feed-forward operations, followed by non-linear activation and normalization. The server applies a sampling or decoding strategy, such as top-k sampling with a temperature parameter, to select output tokens until an end-of-sequence condition is met. The server then decodes the token sequence back to text. As output, the server produces natural language commentary information and, when the prompt includes a user question, response information.

### Step 14:

The server post-processes and packages generated text.

The server takes, as input, the natural language commentary information and response information produced in Step 13. The server performs text normalization operations, such as trimming whitespace, limiting length, and filtering out prohibited words according to a predefined list. The server may also insert line breaks or annotate the text with metadata such as event identifiers and display duration. The server encapsulates the processed text and metadata into a structured message format. As output, the server generates a response message containing commentary items and, if applicable, a response to a user question.

### Step 15:

The server transmits commentary and response information to the terminal.

The server uses, as input, the response message constructed in Step 14 and the network address of the terminal. The server serializes the message and sends it over the network via a transport protocol. The server may apply compression or batching, combining multiple commentary items when they belong to the same time window. The output of this step is a network packet stream directed to the terminal, containing the commentary information and response information.

### Step 16:

The terminal receives and parses commentary and response information.

The terminal takes, as input, the network packets from the server. The terminal uses its communication stack to reassemble packets into the original response message, then parses the structured data to extract text fields, timing information, and association with particular events. The terminal stores these extracted items in an in-memory data structure, such as a list of overlay objects indexed by event time. As output, the terminal produces a set of prepared overlay items ready for rendering.

### Step 17:

The terminal overlays commentary information on image information.

The terminal uses, as input, the set of overlay items from Step 16 and current image frames from the frame buffer created in Step 4. The terminal checks the current time or frame index and selects overlay items whose display time range covers the current frame. The terminal uses a graphics rendering library to draw text strings and background shapes onto an off-screen buffer, performing operations such as font rasterization, alpha blending, and coordinate transformation. The terminal then composites this off-screen buffer with the original image frame to form a combined frame. As output, the terminal generates composited frames containing both the live or recorded image information and the overlaid commentary text.

### Step 18:

The terminal displays the composited frames to the user.

The terminal uses, as input, the composited frames from Step 17. The terminal passes these frames to the display driver, which converts the digital image data to signals for the display hardware. The terminal updates the display at a target frame rate (for example, 30 frames per second), resulting in smooth playback. The output of this step is the visual presentation of the competitive activity and synchronized commentary information to the user on the display.

### Step 19:

The user observes the presentation and optionally submits a question.

The user takes, as input, the visual and any audio presentation of the competitive activity and commentary shown by the terminal in Step 18. The user processes this information and, if clarification or additional information is desired, initiates a question by interacting with the user interface. This output is manifested as an intention to ask a question, realized through voice speech or text entry in subsequent steps.

### Step 20:

The terminal captures user voice input or text input for a question.

The terminal uses, as input, the user's interaction with an input control, such as pressing a microphone icon or focusing a text field. For voice input, the terminal records audio samples from the microphone, segments the audio into frames, and forwards the audio to a speech recognition module. The speech recognition module performs feature extraction and decoding to convert speech to text. For text input, the terminal directly acquires characters entered via the on-screen keyboard. The terminal outputs normalized question text, together with a timestamp and the current session identifier.

### Step 21:

The terminal transmits the user question to the server.

The terminal takes, as input, the normalized question text from Step 20 and the associated metadata. The terminal encapsulates this into a request message, optionally including the current score, last event type, and virtual entity ID. The terminal sends the message to the server via the communication interface. The output of this step is a network message containing the user question and context information.

### Step 22:

The server processes the user question and updates the prompt sentence.

The server uses, as input, the network message from Step 21 containing the question text and context. The server performs natural language processing on the question text, including tokenization and intent detection, to identify the focus of the question (for example, rules, tactics, or a particular event). The server retrieves the latest competitive context information from memory or the database and, if necessary, resolves references in the question (such as “that goal” or “the last foul”). The server also updates the estimated emotional state based on the wording of the question. The server then constructs a new prompt sentence that includes a description of the current context, the text of the user's question, and explicit instructions on how to answer. For example, the server may output:

“You are a friendly virtual sports commentator. Context: A defender committed a late tackle resulting in a yellow card. User question: ‘Why did the referee give a yellow card?’ Explain the reason briefly and clearly in one or two sentences.”

This updated prompt sentence then serves as input to generative processing as in Step 13.

### Step 23:

The server generates and returns an answer to the user's question.

The server takes, as input, the updated prompt sentence from Step 22. The server feeds this prompt into the generative AI model, performs token-level inference as in Step 13, and generates a response text that directly addresses the user's question. The server post-processes the text to meet length and style constraints and packages it into a structured response message. The server transmits this message to the terminal via the network. As output, the server provides a natural language answer tailored to the user's question and current context.

### Step 24:

The terminal displays the answer to the user.

The terminal uses, as input, the structured response message received from the server in Step 23. The terminal parses the response text and inserts it into a conversation view, such as a chat-style window, while continuing to display the live or recorded image information and overlays. The terminal may also render an additional overlay or visual indicator near the virtual entity to signify that an answer has arrived. The terminal outputs the updated user interface, in which the user can read the answer and, if desired, continue the interaction with follow-up questions.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional systems for providing sports commentary and educational content primarily rely on fixed rule sets and static mappings between pre-defined text templates and pre-defined motion clips. Such systems typically select commentary and motion data based only on coarse metadata, such as sport type or event type, and do not interpret fine-grained user intent expressed in natural language. As a result, these systems are unable to flexibly respond to diverse, context-dependent user requests, such as detailed explanations of specific plays or personalized viewpoints on tactical movements.

Further, conventional systems generally treat motion selection and commentary generation as separate, loosely coupled processes. Motion data is often selected solely according to simple indexes, while commentary is generated from static scripts. This separation prevents the system from dynamically coordinating motion playback and commentary content in response to a particular user prompt sentence and real-time game situation, thereby limiting the interactivity and educational value of the experience.

In addition, existing solutions typically do not exploit generative artificial intelligence models to analyze prompt sentences and candidate motion metadata in combination. Instead, any natural language processing is either absent or limited to keyword matching, which results in inaccurate motion selection when the user employs complex phrasing, context-dependent references, or specific constraints (for example, viewpoint or timing). This limitation degrades the relevance and precision of the presented motion sequence.

Moreover, known systems do not sufficiently leverage user emotional state or accumulated interaction history to adapt the style of commentary and motion presentation. Even when some form of user preference is recorded, it is often used only to select between coarse profiles (for example, “enthusiastic” vs. “calm”) and does not refine the underlying computational pipeline for mapping prompt sentences to motion data. Consequently, the system cannot continuously improve its behavior as more user interactions occur, and cannot optimize the generative AI model inputs or commentary-style parameters to the specific user. Accordingly, there is a need for an improved computer-implemented system and method that (i) tightly integrates a motion information storage unit with a generative artificial intelligence model, (ii) uses prompt sentences and candidate motion metadata as joint input to compute a more accurate selection of motion data, (iii) coordinates motion control information and explanatory commentary information for a virtual character in response to user intent and game context, and (iv) dynamically adapts commentary style and motion style based on user emotional state and interaction history, thereby improving the technical functioning of the computer system in providing interactive sports commentary and motion visualization.

The specific processing by the specific processing unit 290 of the data processing device 12 in Example 2 is realized by the following means.

The present invention provides a server comprising a processor configured to provide a user interface via a client device that enables a user to configure appearance attributes, voice attributes, and motion attributes of a virtual character; to analyze image information or video information acquired by a portable information terminal to extract competition-type information and game-situation information and to generate display control information for superimposing the virtual character on the image information or the video information; to manage a motion information storage unit that stores motion information for a plurality of types of competitions and, based on the competition-type information and the game-situation information, to search candidate motion information and acquire identification information and attribute information corresponding to the candidate motion information; to generate input information for a generative artificial intelligence model using a prompt sentence including a natural-language query from the user together with the attribute information relating to the candidate motion information, to cause the generative artificial intelligence model to output motion category information related to an intention of the prompt sentence, to evaluate the candidate motion information based on output information from the generative artificial intelligence model, and to select at least one piece of optimal motion information from among the candidate motion information; to convert motion data corresponding to the optimal motion information into motion control information applicable to a skeletal structure of the virtual character and transmit the motion control information to the portable information terminal; to supply the generative artificial intelligence model with input information including the prompt sentence and attribute information relating to the optimal motion information, to cause the generative artificial intelligence model to generate explanatory text information related to the optimal motion information, and to transmit commentary control information for outputting the explanatory text information as commentary text information of the virtual character to the portable information terminal; to estimate an emotional state of the user based on at least one of facial information, voice information, and operation information of the user, and to generate commentary-style adjustment information for changing at least one of an expression style of the explanatory text information and a motion style of the virtual character in accordance with the emotional state; and to control the virtual character to perform question-and-answer processing and live commentary related to a sport while referring to the motion information storage unit, based on the commentary-style adjustment information and the optimal motion information. This enables a computer system to perform an integrated, AI-assisted pipeline that jointly interprets prompt sentences and motion metadata, selects and adapts motion data and commentary content in real time, and dynamically adjusts presentation style according to user-specific emotional and historical signals, thereby improving the technical functioning of the system in generating contextually accurate and personalized sports commentary and motion visualization.

The term “processor” refers to a hardware computing element, such as a central processing unit or graphics processing unit, that executes instructions to perform the functions described in the claims, including user interface control, data analysis, motion information management, and interaction with a generative artificial intelligence model. The term “user interface” refers to a combination of software and hardware components, including at least a display unit and an input unit, that enables a user to view information and provide commands or data, such as configuring attributes of a virtual character and entering a prompt sentence.

The term “display unit” refers to an output device, such as a screen or other visual display component, that presents graphical or textual information, including images or video and a superimposed virtual character, to the user.

The term “input unit” refers to an input device or mechanism, such as a touch panel, keyboard, mouse, or microphone, that allows the user to input information, including configuration data for a virtual character and natural-language queries.

The term “virtual character” refers to a computer-generated avatar or graphical agent, having appearance attributes, voice attributes, and motion attributes, that is displayed to the user and performs actions and commentary under control of the processor.

The term “appearance attributes” refers to parameters defining visual aspects of the virtual character, including at least body shape, clothing, colors, and facial features, which determine how the virtual character is rendered on the display unit.

The term “voice attributes” refers to parameters defining audio characteristics of the virtual character's speech output, including at least voice type, tone, speaking speed, and language, used when outputting commentary text information as speech.

The term “motion attributes” refers to parameters defining behavioral or animation-related characteristics of the virtual character, including at least motion style, intensity, and tempo, which influence how motion data is applied to the virtual character.

The term “portable information terminal” refers to a mobile electronic device, such as a smartphone or tablet computer, that includes at least a processor, a display, an input device, and a communication interface, and that acquires image information or video information and communicates with the server.

The term “image information” refers to still image data captured or obtained by the portable information terminal, including camera images or stored images, which represent a scene such as a sports venue or a display of a sports match.

The term “video information” refers to time-series image data, such as streaming video, recorded video, or live camera footage, acquired or reproduced by the portable information terminal and representing at least a sports event or match.

The term “competition-type information” refers to information indicating a type or category of a sport or competition, such as soccer, basketball, or other athletic activity, extracted from the image information, the video information, or associated metadata.

The term “game-situation information” refers to information indicating a state or context of an ongoing or recorded sport event, including at least game time, field position, player role, or event type, derived from the image information, video information, or other contextual data.

The term “display control information” refers to data and parameters used to control the position, scale, timing, and appearance of the virtual character when superimposed on the image information or the video information on the portable information terminal.

The term “motion information storage unit” refers to a logical or physical storage component, such as a database or memory, that stores motion information for a plurality of types of competitions, together with associated metadata such as index information and attribute information.

The term “motion information” refers to data describing a sequence of physical movements, including at least joint positions, joint rotations, or keyframe animation data, which can be applied to a skeletal structure of a virtual character.

The term “candidate motion information” refers to one or more items of motion information selected from the motion information storage unit on the basis of at least the competition-type information and the game-situation information, prior to evaluation by a generative artificial intelligence model.

The term “identification information” refers to data, such as an identifier or key, that uniquely distinguishes a particular piece of motion information or candidate motion information within the motion information storage unit.

The term “attribute information” refers to metadata associated with motion information, including at least competition type, motion type, difficulty classification, role classification, or textual description, used for searching, filtering, and evaluating motion data.

The term “generative artificial intelligence model” refers to a machine learning model that receives input information including at least a prompt sentence and attribute information, and generates output information such as motion category information, explanatory text information, or ranking information for candidate motion information.

The term “prompt sentence” refers to a natural-language sentence or text string input by the user, expressing a query or request related to sports motion, explanation, or commentary, and used as a primary input to the generative artificial intelligence model.

The term “input information” refers to data supplied to the generative artificial intelligence model, including at least the prompt sentence and attribute information relating to candidate motion information or optimal motion information.

The term “output information” refers to data generated by the generative artificial intelligence model in response to the input information, including at least motion category information, evaluation scores, selected identifiers, or explanatory text information.

The term “motion category information” refers to information indicating a category or class of motion, such as a goal shot, defensive move, pass, or other sports action type, inferred from the prompt sentence and the attribute information.

The term “optimal motion information” refers to at least one piece of motion information selected from among the candidate motion information on the basis of the output information from the generative artificial intelligence model as best matching the intention of the prompt sentence and the game-situation information.

The term “motion data” refers to numerical data representing time-dependent transformations, including at least positions, rotations, or scaling of skeletal joints or body parts, which are used to animate the virtual character.

The term “skeletal structure” refers to a hierarchical set of virtual joints or bones defining the internal structure of the virtual character, to which motion data is applied to produce animation.

The term “motion control information” refers to data derived from motion data and formatted for application to the skeletal structure of the virtual character, including timing and transformation parameters used by an animation engine.

The term “explanatory text information” refers to textual data generated by the generative artificial intelligence model that describes, explains, or comments on the optimal motion information or associated sports play.

The term “commentary control information” refers to data that specifies how explanatory text information is output by the virtual character, including timing, segmentation, and mapping of text to speech or display, on the portable information terminal.

The term “commentary text information” refers to text presented as commentary by the virtual character, including descriptions, explanations, and responses in connection with the sports event and the motion information.

The term “emotional state” refers to an inferred psychological state of the user, such as excitement, interest, confusion, or boredom, estimated by the processor based on at least one of facial information, voice information, and operation information.

The term “facial information” refers to image-based or sensor-based data representing the user's face or facial expressions, obtained for example from a camera, and used for estimating the emotional state.

The term “voice information” refers to audio data of the user's speech, including prosodic features such as pitch, volume, and tempo, used for estimating the emotional state or for recognizing a spoken prompt sentence.

The term “operation information” refers to data representing user interactions with the portable information terminal, such as touch operations, button presses, or input timing, which are used to infer the emotional state or engagement level.

The term “commentary-style adjustment information” refers to data specifying modifications to at least one of the expression style of the explanatory text information and the motion style of the virtual character, determined in accordance with the estimated emotional state. The term “question-and-answer processing” refers to processing in which the virtual character receives user queries expressed in prompt sentences and provides responsive commentary or explanations using motion information and explanatory text information. The term “live commentary” refers to commentary generated and output by the virtual character in temporal relation to an ongoing or reproduced sports event, using motion information and explanatory text information that are selected and adapted in real time or near real time.

The term “history information” refers to recorded information including past prompt sentences, previously selected optimal motion information, and corresponding emotional states of the user, used to update processing parameters or model inputs.

The term “learning processing” refers to computational procedures that update at least one of the input information for the generative artificial intelligence model and the commentary-style adjustment information on the basis of the history information, so as to improve future selection of motion information and commentary generation.

The term “index information” refers to structured metadata associated with motion information, including at least competition type, motion type, difficulty classification, and role classification, used to organize and retrieve motion information from the motion information storage unit.

The term “search control” refers to processing performed by the processor to retrieve candidate motion information from the motion information storage unit based on the index information, competition-type information, game-situation information, or combinations thereof.

In one embodiment, a server, a terminal, and a user cooperate to realize the present invention. The server includes at least one processor, a main memory, a non-volatile storage device, and a network interface. The terminal includes a processor, a display, an input device, an audio output device, and optionally a camera and a microphone. The user operates the terminal to configure a virtual character and to submit a prompt sentence in natural language. The server uses a general-purpose operating system, such as a server-class operating system, and application software implemented, for example, using a programming language such as Python and a relational database management system such as a relational database server. The server further uses a generative AI model implemented as a neural network, for example, a transformer-based language model with multiple attention layers, trained on sports-related text and motion descriptions. The terminal uses a mobile operating system, such as a handheld device operating system, and a rendering engine, such as a 3D game engine, for example a commercially available cross-platform graphics engine, to render the virtual character and display received motion.

The server manages a motion information storage unit implemented as one or more database tables and associated binary data files. The server stores motion information as structured records, each record including a motion identifier, competition type, motion type, difficulty classification, role classification, and a reference to time-series joint data. The server stores the joint data as sequences of joint positions and joint rotations sampled at a fixed frame rate. Each sequence is stored in a compressed numerical format, for example as arrays of floating-point values representing joint angles in a skeletal hierarchy. The server creates index information, such as B-tree indexes, on competition type, motion type, and difficulty classification, to accelerate search operations.

The server uses the generative AI model as a component in a motion selection pipeline rather than as a black box. The server represents each candidate motion by a set of features derived from the attribute information. These features include categorical features (competition type, motion type, role), numerical features (difficulty score, typical duration, average speed), and textual features (motion description text). The server converts the textual features into vector representations using an embedding layer of the transformer model, and concatenates these with normalized numerical features to form input vectors. The server then processes the prompt sentence through the same embedding layer and attention blocks to obtain a prompt representation. The server computes similarity scores between the prompt representation and each candidate motion representation using an attention-based scoring function or a cosine similarity implemented on top of linear projections.

The server trains the generative AI model with a supervised learning method prior to deployment. The server prepares training data consisting of pairs of prompt sentences and ground-truth motion identifiers, together with candidate sets and labels indicating correct and incorrect matches. The server defines a loss function, such as a cross-entropy loss over candidate motions or a pairwise ranking loss that penalizes wrong ranking orders. The server updates the model weights by gradient descent using an optimization algorithm such as Adam, and applies regularization techniques such as dropout and weight decay to avoid overfitting. The server may augment the training data by generating paraphrases of prompt sentences and by perturbing motion attribute features, thereby improving robustness and coverage of the model.

The server uses the same neural architecture at inference time to compute evaluation scores for candidate motion information. The server passes the prompt sentence and the list of candidate motion attributes to the model in a structured textual format, such as a prompt that enumerates the candidates with numbered descriptions. The model outputs a ranking or selection of motion identifiers along with explanatory text that indicates which attributes are most relevant. This processing is not a mere automation of human decision-making, because the model internally uses high-dimensional continuous representations and non-linear attention mechanisms that enable it to consider detailed combinations of attributes, temporal relationships, and contextual phrasing in the prompt sentence. The server thus achieves improved selection accuracy and reduced manual tuning compared with static rule-based systems.

The server also manages commentary generation. The server reuses the generative AI model or employs a related model architecture to generate explanatory text information. The server conditions the model on both the prompt sentence and the attributes of the selected optimal motion information, including competition type, role, difficulty, and key temporal segments. The server structures the input so that the model is instructed to generate step-by-step explanations rather than generic commentary. For example, the server may include annotations such as “phase 1: approach,” “phase 2: jump,” and “phase 3: landing” in the input to guide the model toward temporally aligned explanations. This yields commentary that is synchronized with the motion data and that can be segmented for incremental playback. In one embodiment, the terminal renders the virtual character using a 3D engine. The terminal holds a skeletal structure for the virtual character, defined as a hierarchy of bones with parent-child relationships. Each bone has a default transform and constraints. The terminal receives motion control information from the server, where motion control information includes joint transforms per frame, normalized to the character's skeleton. The terminal maps each joint index in the motion data to a corresponding bone in the character skeleton. The terminal applies the transforms frame-by-frame to produce animation. The terminal interpolates between frames using spline interpolation or linear interpolation to produce smooth motion. The terminal executes these operations using hardware acceleration provided by a graphics processing unit, which improves rendering performance and reduces latency, thereby enabling real-time or near real-time playback while the user is watching a sports event.

The terminal may optionally use a local generative AI model specialized for motion adaptation. In this case, the terminal represents incoming motion sequences as fixed-length vectors using a temporal encoder, such as a series of one-dimensional convolutional layers or a recurrent neural network. The terminal then applies a style transfer module, such as a small feedforward network, conditioned on the motion attributes and the user-selected motion style (for example, realistic or exaggerated). The terminal decodes the transformed representation back into a sequence of joint transformations. The terminal uses a loss function that penalizes deviation from physically plausible trajectories and excessive joint acceleration during training. This on-device processing allows the terminal to adapt motions to a wide variety of character sizes and styles without increasing bandwidth usage, thus reducing communication load between the terminal and the server.

The server uses specific data structures and processing sequences to reduce latency and improve computational efficiency. The server stores motion attribute information in normalized relational tables and caches frequently accessed attribute vectors in memory. The server precomputes embedding vectors for motion descriptions and stores them as dense numerical arrays in a vector index structure. When a new prompt sentence arrives, the server computes its embedding once, then performs approximate nearest neighbor search against the vector index to obtain an initial candidate set. The server then passes only this reduced candidate set to the generative AI model for detailed ranking. This two-stage retrieval process reduces the number of candidates evaluated by the model, lowers inference time, and decreases processor load, thereby improving system throughput.

The server also processes user emotional state. The server receives facial information and voice information as compressed sensor data from the terminal, and extracts features using pre-trained neural networks. For example, the server employs a convolutional network to map facial images to emotion-probability vectors, and a recurrent network to map speech prosody features to arousal and valence scores. The server then fuses these features with operation information, such as interaction speed and frequency of prompt submissions, to estimate an emotional state. The server uses rule-based mappings or another learned model to convert the emotional state into commentary-style adjustment information that modifies verbosity, tone, and technical depth of the generated commentary. This processing affects internal parameters sent to the generative AI model, such as desired length, level of detail, or emotive markers, thereby technically altering how the model generates text.

The server stores interaction history, including previous prompt sentences, selected optimal motion information, emotional states, and timing information, in a history information database. The server periodically extracts this data to update user-specific profiles, which include preferred competition types, complexity levels, and typical emotional reactions. The server adjusts model input prompts and search weights based on these profiles. For instance, if a user repeatedly asks for detailed defensive explanations, the server increases weights for defensive motion types in future candidate searches and sets commentary generation parameters to favor detailed tactical descriptions. This learning processing improves personalization accuracy and reduces repeated irrelevant results, which in turn improves computing efficiency by avoiding unnecessary generative calls for unsuitable motions. The user operates the terminal to invoke the system. The user launches an application, configures a virtual character by selecting attributes such as uniform color, hairstyle, voice style, and preferred motion style. The user then watches a sports match on the terminal, either as streaming content or through an augmented reality view of a physical venue. When the user desires additional explanation, the user enters a prompt sentence, for example: “Show me the motion of scoring a goal in a soccer match from the striker's viewpoint.” In another example, the user inputs: “Explain in detail the defensive movement in this play, including body positioning and footwork.” In a further example, the user inputs: “Demonstrate how a basketball player performs a step-back three-point shot.” The terminal transmits these prompt sentences to the server together with context data, and the server performs the above-described selection and commentary generation.

The terminal receives the selected motion control information and commentary control information and synchronizes motion playback with ongoing game time. The terminal overlays the virtual character on the live video or AR scene, using the display control information received from the server, and presents the explanatory text information as on-screen captions and/or synthesized speech. The user visually observes the virtual character's movement and listens to the commentary. This integration of motion data and commentary based on the generative AI model's combined processing of prompt sentences and motion metadata provides a richer and more precise educational experience than conventional static systems.

The server and the terminal thus cooperate to perform a technical process that goes beyond merely displaying information. The server performs specific computational operations to retrieve, embed, index, and rank motion data, and to generate synchronized commentary. The terminal performs skeletal mapping, motion adaptation, and real-time rendering, and optionally on-device neural processing for motion style transfer. These operations are tied to concrete hardware resources, such as processors, memory hierarchies, network interfaces, and graphics accelerators, and achieve technical effects including reduced latency, improved motion-selection accuracy, reduced bandwidth consumption, and improved utilization of computational resources.

In an alternative embodiment, the server may run the generative AI model on a dedicated accelerator, such as a specialized AI processor, and may partition the model so that part of the attention layers run on the server and part run on the terminal. The server sends intermediate representations instead of full motion or text data, and the terminal completes the inference locally. This configuration reduces the amount of raw text and motion data transmitted over the network and improves privacy, while distributing computational load across devices. In another embodiment, the motion information storage unit may be implemented as a distributed database, and the server aggregates motion candidates from multiple physical nodes, but the search control and model-based evaluation remain as described.

In yet another embodiment, the terminal does not perform on-device generative AI processing but relies solely on the server. In this case, the server additionally performs a motion retargeting algorithm that scales joint positions based on a character-size vector sent from the terminal. The server computes scaling matrices and applies them to joint coordinates using matrix multiplication routines optimized with vector instructions. The server then transmits retargeted motion control information to the terminal, which only needs to perform final rendering. This embodiment simplifies the terminal hardware requirements while still leveraging the improved motion-selection and commentary-generation pipeline.

Through these embodiments, the server and the terminal implement a concrete, technical mechanism that uses a generative AI model, motion information storage, and prompt sentence processing in a non-conventional way. The system uses specific data structures, neural architectures, indexing strategies, and device-level processing steps to achieve improved accuracy, speed, and resource usage in the generation and presentation of sports-related motion and commentary, thereby improving the functioning of the computer system itself.

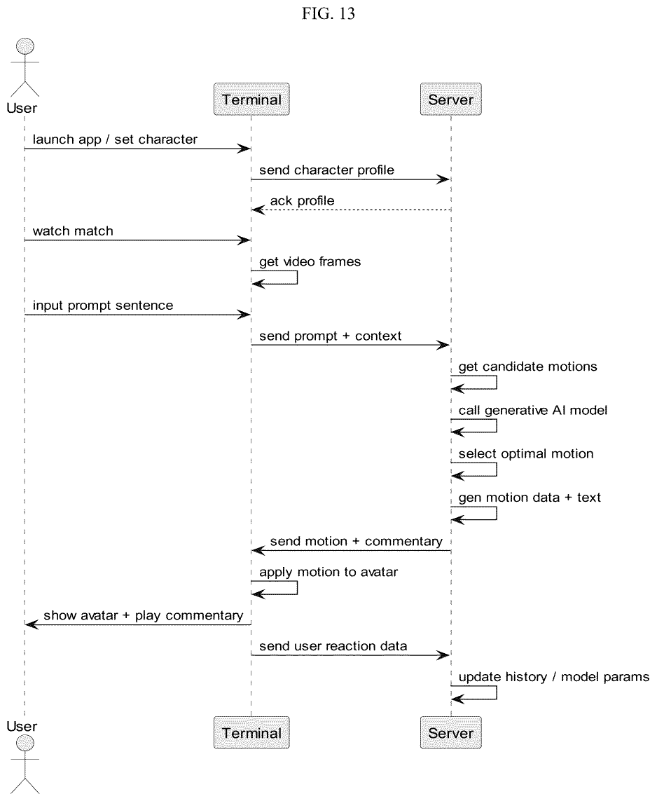

The following describes the processing flow using FIG. 13.

### Step 1:

The user launches an application on the terminal and configures a virtual character. The terminal displays a character configuration screen using a rendering engine and presents selectable options for appearance attributes, voice attributes, and motion attributes.

Input: user operations on the display and input unit (touches, selections, text inputs).

Output: a virtual character profile including fields such as appearance attributes (body shape, clothing color, facial features), voice attributes (voice type, language), and motion attributes (motion style, intensity)

The terminal stores this profile as a structured data object in memory and renders a preview animation of the virtual character to confirm the configuration.

### Step 2:

The terminal transmits the virtual character profile to the server. The terminal serializes the profile into a data structure, such as JSON, and sends it via a network interface using a secure protocol.

Input: the virtual character profile object created in Step 1.

Output: a network request containing the profile data addressed to the server, and a confirmation response received from the server.

The terminal encodes the profile fields into key-value pairs, attaches user identification information, and initiates a communication session to deliver the configuration to the server.

### Step 3:

The server receives and stores the virtual character profile. The server parses the incoming data, validates that mandatory fields are present, and assigns a profile identifier.

Input: the serialized virtual character profile transmitted from the terminal. Output: a stored profile record in a motion information storage unit or a user-profile database, associated with a unique profile identifier returned to the terminal.

The server executes database insert or update operations, registers the profile under the user account, and sends the profile identifier as part of an acknowledgment message.

### Step 4:

The terminal acquires image information or video information related to a sports event. The terminal either receives streaming content from a remote source or captures live images from a camera.

Input: sensor data from a camera or decoded video frames from a streaming source. Output: a sequence of image frames or video frames stored in a frame buffer and ready for analysis and display.

The terminal decodes compressed video, converts pixel formats as needed, and presents the frames on the display while also buffering them for further processing.

### Step 5:

The server or the terminal analyzes the image information or video information to derive competition-type information and game-situation information. In one embodiment, the server performs this analysis based on metadata or auxiliary feeds.

Input: image information or video information, and optionally match metadata such as league, teams, or sport category.

Output: competition-type information (for example, soccer or basketball) and game-situation information (for example, time in match, field zone, player role) encoded as structured data. The server processes the input by applying classification models or rule-based parsing of metadata, mapping known patterns (such as field lines or scoreboard formats) to competition types and current game state parameters.

### Step 6:

The server manages a motion information storage unit and retrieves candidate motion information based on the derived competition-type and game-situation information.

Input: competition-type information and game-situation information from Step 5. Output: a set of candidate motion records, each including identification information and attribute information such as motion type, difficulty classification, and role classification.

The server performs database queries using index information, filters motions by competition type and motion type, and retrieves both metadata and references to the underlying joint data for each candidate.

### Step 7:

The user submits a prompt sentence describing a desired explanation or motion. The terminal displays an input field, and the user enters text or speaks into the microphone, which is converted to text by a speech recognition component.

Input: user-generated natural-language text, such as “Show me the motion of scoring a goal in a soccer match from the striker's viewpoint,” “Explain in detail the defensive movement in this play, including body positioning and footwork,” or “Demonstrate how a basketball player performs a step-back three-point shot.”

Output: a prompt sentence stored as a text string ready to be transmitted to the server.

The terminal normalizes the text (for example, lowercasing, removing noise), associates it with current context information (competition-type and game-situation information), and packages it into a request structure.

### Step 8:

The terminal sends the prompt sentence and context to the server. The terminal constructs a request containing the user identifier, the virtual character profile identifier, the prompt sentence, and the competition-type and game-situation information.

Input: the prompt sentence and context data derived in Steps 5 and 7.

Output: a network request delivered to the server containing all relevant parameters for motion selection and commentary generation.

The terminal serializes the request into a defined message format, transmits it through the network interface, and awaits a response from the server.

### Step 9:

The server generates input information for a generative AI model using the prompt sentence and the attribute information of the candidate motion information.

Input: the prompt sentence from the terminal and the attribute information of the candidate motion set from Step 6.

Output: a structured model input consisting of text that enumerates candidates and encodes their attributes, or a set of numerical feature vectors representing the prompt and candidates. The server tokenizes the prompt sentence, encodes candidate attributes into descriptive phrases, and combines them into a single sequence or into separate vectors, arranging them according to the input format required by the generative AI model.

### Step 10:

The server uses the generative AI model to evaluate and rank the candidate motion information.

Input: the structured model input created in Step 9.

Output: output information including motion category information, ranking scores for each candidate, and optionally a selected motion identifier or a small subset of optimal candidates. The server forwards the input to a transformer-based neural network, which processes token embeddings through attention layers to model relationships between prompt terms and motion attributes, computes similarity or relevance scores, and outputs logits or scores that the server converts into a ranking of candidate motions.

### Step 11:

The server selects at least one piece of optimal motion information based on the output of the generative AI model.

Input: the ranked list of candidate motions and the associated scores from Step 10.

Output: a selected optimal motion identifier, and the corresponding motion information and attribute information.

The server applies decision criteria such as maximum score, score thresholds, or diversity constraints, extracts the top-ranked motion(s), and prepares them for motion data retrieval and commentary generation.

### Step 12:

The server retrieves and converts motion data corresponding to the optimal motion information into motion control information that is applicable to the skeletal structure of the virtual character.

Input: the optimal motion identifier from Step 11 and the stored motion data in the motion information storage unit.

Output: motion control information containing joint transformations per frame mapped to the skeleton definition of the virtual character.

The server reads the raw joint data, performs coordinate normalization and frame-rate adjustment if needed, maps each joint index to the corresponding bone in the virtual character skeleton, and packages the data into a format expected by the terminal's animation system.

### Step 13:

The server generates explanatory text information related to the optimal motion information using the generative AI model.

Input: the prompt sentence, the attribute information of the optimal motion, and optionally temporal annotations describing motion phases.

Output: explanatory text information that describes the motion, for example a step-by-step explanation of body movements, timing, and technique.

The server constructs a second input for the generative AI model, instructing it to produce explanatory text aligned with the motion phases, feeds this input to the model, and processes the generated text output, such as segmenting it into sentences matching key frames.

### Step 14:

The server estimates the emotional state of the user and generates commentary-style adjustment information.

Input: facial information, voice information, and operation information received from the terminal, together with the current interaction context.

Output: an estimated emotional state (for example, excited, confused, or bored) and commentary-style adjustment parameters (for example, desired level of detail, tone, and speed).

The server extracts features from facial images and voice signals using trained recognition models, combines them with interaction metrics (such as number of recent prompts and reaction time), and applies classification or regression algorithms to derive an emotional state vector. The server then maps this vector to style parameters that will modify the format and tone of the generated commentary.

### Step 15:

The server assembles a response containing motion control information, explanatory text information, and commentary-style adjustment information, and transmits it to the terminal.

Input: motion control information from Step 12, explanatory text information from Step 13, and commentary-style adjustment parameters from Step 14.

Output: a response message sent to the terminal, encapsulating all data necessary for animation and commentary playback.

The server formats the motion data, attaches the text and style parameters as metadata, compresses the payload if necessary, and sends it via the network interface as a structured response.

### Step 16:

The terminal receives the response from the server and prepares the animation of the virtual character.

Input: the response message containing motion control information, explanatory text information, and commentary-style adjustment information.

Output: an internal animation sequence linked to the virtual character's skeleton, and prepared commentary content adjusted according to the style parameters.

The terminal parses the message, loads the motion control information into the animation engine, schedules animation playback according to current game time, and formats the explanatory text for display or text-to-speech conversion, applying parameters such as speed and verbosity.

### Step 17:

The terminal renders the virtual character and plays commentary in synchronization with the sports event.

Input: the prepared animation sequence and formatted commentary content from Step 16, and the ongoing image information or video information displayed on the screen.

Output: a composite display in which the virtual character is animated on top of the sports scene, and synchronized commentary output via text and/or synthesized speech.

The terminal applies joint transformations to the skeletal structure frame-by-frame, updates the character's pose, draws the character using the graphics engine, and overlays it on the live video. The terminal also triggers a text-to-speech engine or on-screen captions according to the commentary-style adjustment information, so that the commentary matches the motion timing and the user's emotional state.

### Step 18:

The server and the terminal update history information for subsequent learning and personalization.

Input: the prompt sentence, the selected optimal motion information, the estimated emotional state, and interaction logs such as timestamps and response times.

Output: updated history records stored on the server and, optionally, summary statistics or preferences cached on the terminal.

The server appends new entries to a history database, aggregates statistics about motion types and commentary styles used for the user, and adjusts future model inputs or search weights.

The terminal may cache recent responses to speed up repeated requests. This continuous update of interaction data allows the system to progressively refine the behavior of the generative AI model and the motion selection process for the user.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional interactive presentation systems that overlay a virtual object on audiovisual content suffer from several technical limitations that reduce system responsiveness, scalability, and the quality of user interaction. First, many systems separate visual rendering logic from natural language response logic, so that event detection in captured image information, motion selection for a virtual object, and text generation for commentary or question answering are not coordinated in a unified processing pipeline. As a result, latency accumulates across subsystems, context is inconsistently propagated, and the system often outputs commentary or answers that are temporally misaligned with the displayed motion of the virtual object.

Second, in existing architectures, user input handling and natural language generation are typically implemented as static or rule-based modules that do not dynamically incorporate rich context, such as the current visual situation, user attributes, and user emotional state. Because the processing components do not synthesize this multi-modal context into a structured representation used for constructing input to a generative AI model, prompt sentences are simplistic, under-specified, or redundant. This leads to inefficient use of computational resources in the generative AI model, unstable output quality, and a high rate of non-responsive or irrelevant generated text.

Third, emotion processing in many systems is either absent or implemented only as a superficial filter on the final output text. Emotion recognition results are not fed back into earlier stages of the pipeline, such as motion selection or prompt construction. As a consequence, the system cannot systematically adapt expression style, motion style, and dialogue strategy to the user's current state, and must instead rely on generic commentary templates. This degrades the effectiveness of the user interface as a human-machine communication medium and forces the user to perform repeated manual adjustments or re-queries, which in turn increases network traffic and processing load.

Fourth, most known solutions do not maintain fine-grained interaction history that links user input, constructed prompt sentences, generative AI model outputs, and emotion information in a unified data structure suitable for learning. Without such structured history, it is difficult to apply statistical or machine learning techniques to optimize prompt templates, style adjustment parameters, and motion selection policies. The system therefore cannot improve its behavior over time, and must be manually reconfigured or hard-coded by developers, which is error-prone and not scalable across many users and content types.

Accordingly, there is a need for an improved computer-implemented system and processing method that: (i) tightly integrates visual analysis, motion selection, emotion estimation, and natural language generation into a coordinated, low-latency processing pipeline; (ii) programmatically constructs rich, context-aware prompt sentences for a generative AI model, based on analysis of user input, visual situation, and user attributes; (iii) uses emotion estimation to control both the linguistic style and the motion style of a virtual display object in a technically systematic manner; and (iv) maintains structured interaction history suitable for machine learning so that the system can automatically adapt and optimize its behavior per user and per content type. Such a system would improve the operation of computer-based interactive presentation platforms by reducing end-to-end latency, stabilizing generative AI behavior, and enhancing the efficiency and personalization of multi-modal human-computer interaction.

The specific processing by the specific processing unit 290 of the data processing device 12 in Application Example 2 is realized by the following means.

The present invention provides a server comprising a processor configured to control an information processing system including a portable information processing apparatus, a motion information storage unit, and a generative information processing model, the processor being configured to provide a user interface that allows a user to set a preferred virtual display object, to analyze image information acquired by the portable information processing apparatus in association with position and orientation information of the portable information processing apparatus and to generate motion information for the virtual display object so that the virtual display object is displayed in superposition on the image information, to search the motion information storage unit in which motion information for the virtual display object is stored in an associatively retrievable manner on the basis of type information and situation information and to generate the motion information for the virtual display object by extracting motion information corresponding to the type information and the situation information associated with the image information, to convert voice information or character information acquired from the user into character string information, to extract intent information and target information from the character string information and to generate analysis result information by integrating the character string information with context information including the image information and the situation information acquired from the motion information storage unit, to select a sentence template for constructing a prompt sentence for response generation on the basis of the analysis result information, user attribute information, and speaker attribute information of the virtual display object and to generate a generation processing prompt sentence by embedding the analysis result information into the sentence template, to input the generation processing prompt sentence to the generative information processing model that executes natural language generation processing and to cause the generative information processing model to generate response text information or commentary text information by inference processing, to perform emotion estimation processing on the basis of facial expression information and voice feature information of the user, to identify emotion information indicating an emotion type and an intensity and to generate style adjustment information for adjusting an expression style of the response text information or the commentary text information and a motion style of the virtual display object in accordance with the emotion information, to generate speech synthesis information and mouth shape information corresponding to the response text information or the commentary text information on the basis of the style adjustment information and to output the speech synthesis information and the mouth shape information in association with the virtual display object so that the virtual display object is superposed on the image information on the portable information processing apparatus, and to store, as history information, input information from the user, the generation processing prompt sentence, a generation result of the generative information processing model, and the emotion information and to perform learning processing to update at least one of the sentence template, the style adjustment information, and selection conditions for the motion information on the basis of the history information. This enables a coordinated improvement of computer operation by unifying visual analysis, motion selection, emotion-aware prompt construction, and generative natural language processing into a single optimized pipeline that reduces latency, stabilizes output quality of the generative AI model, and adaptively personalizes multi-modal interactive commentary and question-and-answer processing for each user while efficiently utilizing computational and storage resources.

The term “processor” refers to a hardware computation unit or a set of hardware computation units, such as one or more central processing units or dedicated processing circuits, that execute machine-readable instructions to perform the functions described herein. The term “user interface” refers to a hardware and software configuration that presents information to a user and receives input from the user, including graphical, textual, audio, and gesture-based components rendered on a display of a terminal or similar device.

The term “user” refers to a human operator who interacts with the system via the user interface to configure settings, provide input, and receive output such as commentary or responses.

The term “virtual display object” refers to a computer-generated graphical object, such as a two-dimensional or three-dimensional avatar or character, that is rendered on a display and can be overlaid on image information to visually appear within a real or virtual scene. The term “portable information processing apparatus” refers to a mobile electronic device, such as a handheld terminal, equipped with at least a processor, a display, a camera, and a communication interface, and capable of executing application software and acquiring image information.

The term “image information” refers to digital data representing one or more still images or frames of moving images acquired by an image sensor of the portable information processing apparatus or received from an external source.

The term “position and orientation information” refers to data indicating at least one of a spatial position and an orientation of the portable information processing apparatus, obtained for example from a motion sensor, a location sensor, or a camera-based tracking module. The term “motion information” refers to data defining a time-varying transformation, pose, or animation of a graphical object or model, including for example joint angle sequences, keyframe data, or control parameters for an animation system.

The term “motion information storage unit” refers to a non-transitory storage device or logical storage structure that stores motion information in association with retrieval indices such as type information, situation information, or attribute information.

The term “type information” refers to classification data indicating at least one of a content category, a competition category, or an event category associated with image information or motion information.

The term “situation information” refers to data that specifies a context or state associated with a scene or event, such as a game phase, a score situation, or a detected event type in the image information.

The term “voice information” refers to digital audio data representing spoken utterances of the user, captured through a microphone or similar acoustic input device.

The term “character information” refers to text data input by the user via a keyboard, touch interface, or similar text input mechanism.

The term “character string information” refers to a sequence of characters obtained by converting voice information through speech recognition or directly receiving character information as text.

The term “recognition processing unit” refers to a functional module implemented by software and/or hardware that converts input signals such as voice information into a symbolic representation such as character string information.

The term “natural language analysis processing unit” refers to a functional module implemented by software and/or hardware that analyzes character string information to derive semantic or syntactic features, including intent information and target information. The term “intent information” refers to data indicating a purpose or objective of a user's utterance, such as a request for an explanation, a request for statistics, or a comment related to an event.

The term “target information” refers to data identifying an object, entity, or concept referenced by the user in an utterance, such as a particular rule, player, team, or event. The term “context information” refers to data describing a surrounding situation relevant to processing user input, including at least image information, situation information, and optionally user attribute information and system state information.

The term “analysis result information” refers to a structured representation that integrates character string information, intent information, target information, and context information for use in subsequent processing stages.

The term “user attribute information” refers to data describing characteristics of the user, such as language preference, skill level, favorite entities, or other preference-related parameters.

The term “speaker attribute information” refers to data describing properties of the virtual display object as a speaking entity, such as persona, tone, role, or style preferences used for generating text or speech.

The term “sentence template” refers to a structured pattern that defines a format for a sentence or group of sentences and includes placeholder fields into which analysis result information or other variables can be inserted to construct a prompt sentence or response. The term “prompt sentence” refers to a natural-language instruction or query constructed by the system and provided as input to a generative AI model, specifying constraints and context for generating response text information or commentary text information.

The term “generation processing prompt sentence” refers to a prompt sentence that has been completed by embedding analysis result information into a selected sentence template and that is used as direct input to a generative information processing model.

The term “generative information processing model” refers to a trained computational model, such as a neural network-based generative AI model, that receives a prompt sentence and produces natural-language text as output by performing inference processing.

The term “response text information” refers to natural-language text generated by the generative information processing model that is intended to answer a user's question or respond to a user's utterance.

The term “commentary text information” refers to natural-language text generated by the generative information processing model that is intended to describe or comment on a situation shown in the image information or related content in real time or near real time. The term “facial expression information” refers to data derived from image information of a user's face that characterizes positions or movements of facial features and is used to infer an emotional state.

The term “voice feature information” refers to data representing acoustic properties of a user's speech, such as pitch, energy, spectral characteristics, and prosody, used for emotion estimation.

The term “emotion estimation processing” refers to a computational process that inputs at least one of facial expression information and voice feature information and outputs emotion information.

The term “emotion information” refers to data indicating an estimated emotional state of the user, including at least an emotion type, such as joy or sadness, and optionally an intensity value.

The term “style adjustment information” refers to control data specifying how to modify at least one of a linguistic style of generated text and a motion style of the virtual display object according to emotion information or user preferences.

The term “expression style” refers to characteristics of text or speech output, such as formality, excitement level, politeness, or length, used to shape response text information or commentary text information.

The term “motion style” refers to characteristics of motion of the virtual display object, such as magnitude, speed, or expressiveness of animations, selected or adjusted in accordance with emotion information or other control data.

The term “speech synthesis information” refers to data used by a speech synthesis engine to generate audio, including at least text to be spoken and optionally prosody control parameters.

The term “mouth shape information” refers to data defining time-varying configurations of a virtual display object's mouth or facial rig, synchronized with speech synthesis information to create visually consistent lip movements.

The term “interactive commentary presentation” refers to a process in which the system outputs commentary text or speech that is temporally coordinated with image information and responds adaptively to user input and emotion in a conversational or interactive manner. The term “history information” refers to data stored over time that records at least user input information, generation processing prompt sentences, generation results of the generative information processing model, and emotion information for one or more interactions. The term “learning processing” refers to computational processing, including at least statistical analysis or machine learning, that uses history information to adjust parameters, templates, or selection rules to improve future system behavior.

The term “competition type” refers to a category indicating a kind of competitive activity or event, such as a sport or game, associated with content processed by the system. The term “content type” refers to a classification indicating a kind of audiovisual or informational content, such as a live event, recorded event, or non-competition program. The term “event type information” refers to data identifying a specific type of event within content, such as a scoring event, rule violation, or major play.

The term “emotion type information” refers to data indicating a category of emotional state, such as joy, anger, surprise, or neutrality.

The term “virtual display object attribute information” refers to data characterizing properties of the virtual display object, such as category, role, or preferred style of expression, that may influence motion or language generation.

The term “interaction history” refers to an aggregation of history information for a given user, including past input content, generation processing prompt sentences, generated text outputs, and user reaction information.

The term “reaction information” refers to data indicating how a user responded to a system output, including for example explicit feedback, follow-up questions, or changes in emotion information.

The term “user preference information” refers to data inferred or determined from interaction history that indicates tendencies or preferences of a user, such as desired detail level, favored tone, or preferred types of content.

The term “commentary presentation” refers to an operation of the system that generates and outputs commentary text or speech concerning events or situations related to the image information or associated content.

The term “question-and-answer processing” refers to an operation of the system that receives a question or request from the user and generates and outputs an answer using the generative information processing model and related components.

In one embodiment, a server, a terminal, and a communication network constitute an information processing system that implements the claimed functions. The server comprises at least one multi-core processor, a main memory, a non-transitory storage device, and a network interface. The terminal comprises at least one processor, a memory, a display, a camera, a microphone, a loudspeaker, a motion sensor, and a wireless communication interface. The server and the terminal execute program modules stored in their respective memories and cooperate to present an interactive virtual display object overlaid on image information, to generate commentary and responses using a generative AI model based on a context-aware prompt sentence, and to adapt behavior according to user emotion and interaction history.

The server executes an operating system such as a general-purpose server OS and executes application software that implements at least a user interface management module, a natural language analysis processing unit, a prompt construction module, a generative AI access module, an emotion integration module, a motion information management module, and a learning processing module. The server stores a motion information storage unit, an interaction history storage unit, and various templates and configuration data in a database system such as a relational database management system.

The terminal executes an operating system for a portable information processing apparatus and a client application implemented, for example, using a game engine such as a three-dimensional rendering engine. The terminal application implements at least an augmented reality rendering module, a camera control module, a microphone control module, a speech recognition client module, an emotion sensing module, and a synchronization module for audio and animation. The terminal acquires image information from the rear camera, facial image information from the front camera, and voice information from the microphone, and transmits appropriate data or features to the server.

The server provides a user interface that allows a user to set a preferred virtual display object. The terminal displays a character selection screen on the display using the game engine, and the user selects a virtual display object by touch input or other input. The terminal transmits an identifier of the selected virtual display object and user identification information to the server via the communication network. The server stores, in the database, a user attribute record that includes at least the virtual display object identifier, language preference, and any style preferences of the user.

The terminal acquires image information by controlling the camera to capture a scene that includes, for example, a sports event displayed on a television or occurring in a venue. The terminal further acquires position and orientation information of the terminal by reading values from a motion sensor, a location sensor, or by visual tracking using image processing. The terminal transmits at least part of the image information and associated metadata to the server, or performs preliminary image analysis locally and transmits situation information to the server.

The server analyzes the image information in association with the position and orientation information. The server uses an image processing library such as a general-purpose computer vision library or a deep neural network model deployed on the server to detect objects and events in the image information. For example, in a soccer scenario, the server detects a ball, players, and a goal area and recognizes an event such as a goal or a foul based on trajectories and spatial relationships. The server maps detected events to type information and situation information such as content type, competition type, event type, game time, and score. The server manages a motion information storage unit in the form of relational tables that store motion information for the virtual display object. The server stores, for each motion sequence, an identifier, a competition type, an event type, an emotion label, and virtual display object attributes. The server stores motion information as animation parameter sequences, skeletal joint angle sequences, or keyframe data suitable for the game engine running on the terminal. The server uses index structures such as composite indexes on competition type, event type, and emotion label to efficiently search the motion information storage unit.

The server searches the motion information storage unit based on the type information and the situation information obtained from analyzing the image information. The server selects motion information corresponding to, for example, a soccer goal event with a joyful emotion state and the attributes of the virtual display object selected by the user. The server generates motion command data that specifies which motion information should be played, at what time, with what blending or scaling parameters. The server transmits this motion command data to the terminal.

The terminal receives the motion command data and loads a corresponding motion clip from a local content repository or from a content distribution server. The terminal applies the motion clip to the virtual display object using the animation subsystem of the game engine. The terminal uses position and orientation information to align the virtual display object in three-dimensional space relative to the captured scene, so that the virtual display object appears to stand at a physically consistent location on the field or in front of the display. By doing so, the terminal controls rendering hardware, including a GPU, to draw the virtual display object frames in real time, thereby implementing concrete control of display hardware and providing a technical effect of low-latency and visually stable augmented reality overlay. The user provides voice information or character information as input. The terminal captures voice information from the microphone and forwards it to a speech recognition service or executes an on-device speech recognizer. The terminal receives character string information as a recognition result. Alternatively, the user directly inputs character information via a soft keyboard, and the terminal forwards the character information to the server as character string information.

The server executes the natural language analysis processing unit on the character string information. The server applies tokenization, part-of-speech tagging, and dependency parsing using a natural language processing library or a trained sequence model. The server extracts intent information, such as “request explanation of rule,” and target information, such as a specific game rule or a specific player name. The server then generates analysis result information that integrates the character string information, intent information, target information, the type information and the situation information from visual analysis, and user attribute information from the user profile.

The server uses the analysis result information to select a sentence template from a template repository. Each sentence template is a parameterized structure that describes how to form a prompt sentence for the generative AI model. For example, a sentence template for a rule explanation might be:

“The user is watching a [competition type] match and asked about [target information]. Explain [target information] in [language] in 2-3 simple sentences.”

The server embeds the analysis result information into the sentence template to generate a generation processing prompt sentence. For example, when the user asks in Japanese about the offside rule in a soccer match, the server generates a prompt sentence such as:

“The user is watching a soccer match and asked about the offside rule. Explain the offside rule in simple Japanese in 2-3 sentences.”

The server further modifies the prompt sentence according to user attribute information and speaker attribute information of the virtual display object, such as a formal commentator style or a friendly character style. The server constructs prompt sentences that specify constraints regarding tone, length, and content, for example:

“You are a friendly virtual commentator. The user is sad because their favorite team conceded a goal. Explain the offside rule in simple English in 2 short, encouraging sentences.”

The server inputs the generation processing prompt sentence to the generative AI model. In one embodiment, the generative AI model is implemented as a transformer-based neural network with multiple self-attention layers, feed-forward layers, and a large vocabulary embedding, trained on a large corpus of text. The server executes the generative AI model on specialized hardware such as a graphics processing unit or a tensor processing unit to improve inference speed. The server sets model parameters such as a temperature parameter, a maximum token length, and a top-k or top-p sampling parameter to control generation behavior. The server performs tokenization of the prompt sentence, feeds token sequences to the model, and obtains probability distributions over tokens at each step. The server selects tokens according to the sampling strategy and concatenates tokens to form response text information or commentary text information.

The server performs post-processing on the generated text, including filtering for prohibited content, enforcing maximum length, and inserting control tags for speech and visuals, such as markers for pauses or emphasis. The server then passes the generated text to the emotion integration module.

The terminal or the server executes emotion estimation processing. The terminal captures facial expression information of the user using the front camera and extracts facial landmarks or encoded facial features using a convolutional neural network. The terminal additionally extracts voice feature information, such as pitch contours, energy, and spectral features, from the voice information using digital signal processing routines. The terminal transmits either raw features or compressed emotion-related features to the server.

The server executes an emotion estimation model, which may be a neural network classifier trained on labeled emotion data. The server inputs facial feature vectors and voice feature vectors into fully connected layers and outputs emotion information, including a distribution over emotion types (for example, joy, sadness, anger, surprise, neutral) and a real-valued intensity. The server uses a cross-entropy loss during training and updates model weights using gradient descent with an optimization algorithm such as Adam. Training data may be augmented via noise injection, random cropping, or time warping to improve robustness. By deploying a trained emotion estimation model, the server achieves higher accuracy and robustness than simple threshold-based rules.

The server generates style adjustment information based on the emotion information, user attribute information, and speaker attribute information of the virtual display object. The server maps each emotion type and intensity to style adjustment parameters, such as text formality level, exclamation frequency, sentence length, and animation amplitude. For example, when the emotion information indicates joy with high intensity, the server sets parameters to use more exclamation marks, higher prosody energy, and larger body gestures. When the emotion information indicates sadness, the server sets parameters to softer wording, slower speech rate, and reduced animation amplitude.

The server applies the style adjustment information to the generated text by modifying expressions, adding supportive language, or reducing intensity words. The server also selects additional motion information from the motion information storage unit associated with the emotional state, such as a cheering gesture for joy or a sympathetic nod for sadness. The server produces a packet that includes final response text information or commentary text information, style tags, and a motion command.

The terminal receives the packet and passes the text to a speech synthesis engine. In one embodiment, the terminal uses a neural network-based text-to-speech model that supports phoneme-level timing output. The terminal selects a voice profile corresponding to the virtual display object and applies prosody parameters derived from the style tags, such as speaking rate and pitch range. The terminal generates audio data and obtains phoneme timing information. The terminal uses this timing information to drive the virtual display object's mouth shape information by mapping phonemes to mouth shapes in the facial rig controlled by the game engine. By tightly synchronizing audio and mouth shape information on the terminal, the system improves audiovisual consistency and reduces perceptual latency, which is a technical improvement over unsynchronized or loosely synchronized systems. The terminal controls rendering of the virtual display object and playback of the synthesized audio with the generated mouth shape information, thereby controlling both display hardware and sound output hardware. The terminal combines these outputs with the real-world image information to present interactive commentary in an augmented reality environment. This sequence directly manipulates graphics pipelines, audio pipelines, and synchronization buffers on the terminal, which are concrete technical operations that go beyond abstract information processing.

The server records, as history information, the user input information, the generation processing prompt sentence, the generated text of the generative AI model, the emotion information, and optionally user reaction information such as whether the user asked a follow-up question. The server stores this history information in a structured schema that links each interaction to user identifiers, time stamps, and context variables. The server periodically executes the learning processing module to perform statistical analysis or machine learning on the history information. For example, the server trains a model that predicts a user's preferred response style based on past emotion reactions and generated text. The server may use gradient-boosted trees or a neural network for this preference prediction. The server adjusts sentence templates, prompt construction rules, and style adjustment mapping tables based on inferred user preference patterns.

Because the server maintains explicit links between user input, prompt sentences, generated output, and emotional responses, the server can perform targeted optimization of prompt templates that stabilize output quality of the generative AI model. For example, when the server observes that a particular prompt formulation leads to longer latencies or off-topic responses, the server modifies the template to be more specific or to constrain the content domain. This adaptive prompting reduces the number of tokens processed and generated by the generative AI model on average, thereby reducing computational load on the model hardware and network traffic between the server and any external AI service.

The described system improves computer technology in several ways. First, by tightly integrating visual analysis, motion selection, prompt construction, emotion estimation, and text generation in a single coordinated pipeline, the server reduces redundant computations and avoids re-processing of context information in separate components. The server reuses analysis result information in both prompt construction and motion selection, which reduces overall processing time and improves throughput compared to architectures that independently compute similar features multiple times.

Second, by using index structures and type/situation labels in the motion information storage unit, the server accelerates retrieval of appropriate motion sequences. The use of composite indexes across competition type, event type, emotion label, and virtual display object attributes allows logarithmic-time retrieval even when the database stores many thousands of motion records. This structure reduces latency in updating the virtual display object's behavior and maintains synchronization with real-world events.

Third, by representing context and style control in structured data (analysis result information, emotion information, style adjustment information) and by generating prompt sentences from templates with embedded structured fields, the server provides more stable and controllable inputs to the generative AI model than raw unstructured user utterances alone. This reduces variance in generated outputs, decreases the probability of irrelevant content, and allows the server to shorten prompts while still conveying sufficient context. Consequently, the system achieves improved computational efficiency and reduced communication overhead when interacting with large generative models.

Fourth, by performing emotion estimation using specific feature extraction and classifier architectures, the server adapts language and motion styles in ways that are not conventional manual operations. The server computes high-dimensional feature vectors and uses non-linear classification boundaries learned from data, which cannot be easily replicated by simple human rules. This processing is not a mere automation of human judgment, but a technical method that uses machine-learned criteria to select style parameters in real time across many parallel sessions.

Fifth, by maintaining interaction history and applying machine learning to update templates, styles, and motion selection conditions, the server allows the system to improve performance over time without manual programming. The server can reduce error rates in understanding user intent and increase user satisfaction metrics measured by reaction information. The learning process applies explicit loss functions, such as cross-entropy between predicted and observed user feedback categories, and updates model parameters via gradient-based optimization. Such techniques represent an improvement in how computer systems manage, store, and exploit historical interaction data for optimization.

In alternative embodiments, the server may host the generative AI model locally or may communicate with an external AI service over a secure network interface. The terminal may perform more or less of the processing, such as running a lightweight natural language analysis model or emotion estimation model on-device. The terminal may use different sensor configurations, such as additional depth sensors or inertial measurement units, to improve registration accuracy of the virtual display object. The motion information storage unit may be implemented as a graph database that encodes transitions between motions depending on event sequences, allowing smoother motion blending.

In another variation, the system may be applied to content types other than sports, such as live concerts or educational content. In such cases, the type information and situation information would encode different event types, but the same architecture of visual analysis, motion selection, prompt construction, generative AI inference, and emotion-aware style adjustment would be used. The server may use specialized generative AI models fine-tuned on commentary data for different domains, while still using the same scheme for constructing prompt sentences and integrating emotion information.

Because the server and the terminal cooperate to perform concrete operations on sensors, displays, audio devices, and network interfaces, and because the described processing pipeline improves latency, stability, and personalization of the system through specific data structures, neural network architectures, template-based prompt construction, and learned style control, the invention is not limited to an abstract idea. Instead, the invention provides a technical solution that improves the functioning of a computer-based interactive presentation system and produces a tangible enhancement in the operation of hardware resources used to implement augmented reality commentary and question-and-answer processing.

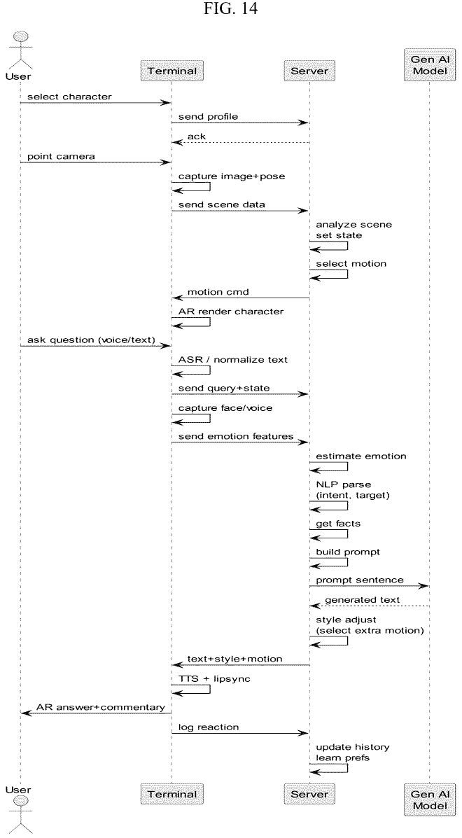

The following describes the processing flow using FIG. 14.

### Step 1:

The terminal presents a character selection user interface and acquires a user profile. The user operates the terminal to select a preferred virtual display object and basic preferences (language, tone, favorite team) via a graphical screen rendered by a game engine. The terminal receives input events (touch coordinates, button selections) as input and converts them into structured selection data including at least a virtual display object identifier and preference flags as output.

The terminal transmits the structured selection data to the server.

The server receives the selection data as input and writes or updates a user profile record in a database table, storing the virtual display object identifier, language preference, and style parameters as output.

### Step 2:

The terminal acquires environmental image information and positional information. The user points the terminal camera at a sports event or a display showing the event. The terminal uses the rear camera to capture frames as input and uses onboard sensors (inertial sensors, location sensors) and/or visual tracking to obtain position and orientation data as input.

The terminal associates the captured frames with corresponding time stamps and sensor readings and generates a sequence of augmented reality frames and pose metadata as output.

The terminal optionally performs preliminary processing, such as downscaling and edge detection, and transmits either raw frames or preprocessed data plus pose metadata to the server as output.

### Step 3:

The server analyzes the image information to determine type information and situation information.

The server receives the image frames and pose metadata as input and applies image processing pipelines, including background segmentation, object detection, and event recognition, using a vision library or a trained convolutional neural network. The server performs data processing that maps pixel-level detections (ball, players, field lines) and motion trajectories to higher-level categories such as competition type, event type (goal, foul, corner), and situation information (current score, game clock) as output. The server stores the situation information in a transient match state store, associating it with the user session as output.

### Step 4:

The server selects motion information for the virtual display object from the motion information storage unit.

The server receives the type information, situation information, and the user's virtual display object identifier from the user profile as input.

The server performs a database query over a motion information storage unit indexed by competition type, event type, emotion label, and virtual display object attributes, and retrieves one or more candidate motion records as intermediate output.

The server applies selection logic that compares candidate motion attributes (e.g., intensity, duration) with situation information and user preferences to choose a best-fitting motion sequence as output.

The server generates a motion command message that includes a motion identifier, timing parameters, blending weights, and any placement offsets as output and transmits this message to the terminal.

### Step 5:

The terminal renders the virtual display object in augmented reality using the received motion information.

The terminal receives the motion command message and pose metadata as input and loads the corresponding animation clip from local storage as intermediate output.

The terminal uses an animation controller in the game engine to apply the animation clip to the virtual display object's skeleton, computing joint transformations per frame based on time and blending weights, and produces frame-by-frame pose matrices as output.

The terminal composes the virtual display object frames with the live camera frames using the pose metadata to align the object in three-dimensional space and outputs composite image frames to the display.

### Step 6:

The user provides a voice or text query during content viewing.

The user speaks a question such as “Explain the offside rule” or “How many goals does this player have this season?” into the microphone, or types text into a chat field presented on the terminal.

The terminal records an audio signal as input and forwards it to a speech recognition engine, or directly captures typed text characters as input.

The terminal performs or receives recognition processing that converts the audio waveform into character string information (normalized text) as output.

The terminal encapsulates the user query text, the current match state identifier, and the user identifier in a request message and transmits this message to the server as output.

### Step 7:

The terminal and the server acquire and estimate user emotion.

The terminal uses the front camera to capture facial images and the microphone to capture voice segments while the user is interacting, and uses these streams as input.

The terminal extracts facial features (such as landmark coordinates or feature vectors from a convolutional network) and acoustic features (pitch, energy, spectral coefficients) as intermediate output.

The terminal transmits the feature vectors to the server, or the terminal performs local classification and transmits provisional emotion labels.

The server receives facial and voice feature vectors as input and applies an emotion classifier model to compute emotion information, including an emotion type (for example, joy or sadness) and a numeric intensity value, as output.

The server associates the emotion information with the user session and stores it in an emotion state store as output.

### Step 8:

The server performs natural language analysis on the user query.

The server receives the user query text and the match state identifier as input and passes the text through a natural language analysis processing unit that performs tokenization, part-of-speech tagging, and syntactic parsing.

The server applies intent classification and entity recognition operations on the parsed text to derive intent information (for example, “request rule explanation,” “request player statistics”) and target information (rule names, player identifiers, team names) as output.

The server queries an application database or external data service using the target information and match state identifier as input and retrieves factual data such as rule definitions or numeric statistics as output.

The server constructs analysis result information by combining the query text, intent information, target information, factual data, type information, situation information, and user attribute information into a structured context object as output.

### Step 9:

The server constructs a context-aware prompt sentence for the generative AI model. The server receives the analysis result information, user attribute information, speaker attribute information of the virtual display object, and emotion information as input. The server selects a sentence template from a template library by matching the intent information (for example, explanation, commentary, comparison) and content domain and obtains a template skeleton as intermediate output.

The server inserts specific values from the analysis result information and user attributes into the template skeleton, performing string substitution and formatting operations to produce a generation processing prompt sentence as output.

For example, the server may generate as output a prompt sentence such as:

“The user is watching a soccer match and asked about the offside rule. Explain the offside rule in simple Japanese in 2-3 sentences.” or

“You are a friendly virtual commentator. The user is sad because their favorite team conceded a goal. Explain the offside rule in simple English in 2 short, encouraging sentences.”

### Step 10:

The server generates response text information or commentary text information using the generative AI model.

The server receives the generation processing prompt sentence as input and tokenizes it into subword units according to the vocabulary of a transformer-based generative AI model.

The server feeds the token sequence into the model and performs forward inference through multiple self-attention layers and feed-forward layers, producing probability distributions over next tokens at each time step as intermediate output.

The server applies a decoding strategy (such as sampling with temperature and top-k/top-p constraints) to select successive tokens, concatenating tokens to form response text information or commentary text information as output.

The server post-processes the generated text by applying filtering rules and length constraints, and inserts markup tokens indicating prosody or emphasis when needed as output.

### Step 11:

The server applies style adjustment to the generated text and selects any additional motion. The server receives the raw generated text, the emotion information, the user attribute information, and speaker attribute information as input.

The server performs rule-based and learned mapping operations that convert emotion type and intensity to style parameters, such as desired sentence length, exclamation density, politeness level, and semantic intensity, and produces style adjustment information as output. The server modifies the generated text by replacing certain expressions, inserting or removing modifiers, and shaping sentence structure according to the style adjustment information as output.

The server optionally queries the motion information storage unit again using the emotion information and event type as input to select an auxiliary motion sequence (for example, an encouraging gesture or a celebratory gesture) as additional motion command data output. The server packages the final styled text, style adjustment tags, and motion command data into a response packet as output and transmits this packet to the terminal.

### Step 12:

The terminal synthesizes speech and synchronizes lip movements with the virtual display object.

The terminal receives the response packet containing styled text, style tags, and motion command data as input.

The terminal forwards the styled text and style tags to a text-to-speech engine, which converts the text into an audio waveform and phoneme timing information by applying a trained acoustic model and vocoder, and outputs audio samples and phoneme time stamps as output.

The terminal maps phoneme sequences and timing to mouth shape information by referencing a phoneme-to-viseme mapping table, generating time-aligned facial rig control parameters as output.

The terminal applies the new motion command data, if any, to the virtual display object's animation system and combines body motion, facial motion, and mouth shape information, computing per-frame pose and morph targets as output.

The terminal plays the synthesized audio through the loudspeaker and renders the virtual display object with synchronized lip movements and gestures over the live camera feed on the display.

### Step 13:

The server and the terminal store interaction history and update models over time. The terminal reports interaction metadata such as whether the user continued the conversation, asked follow-up questions, or closed the interface as input to the server. The server receives interaction metadata, together with the user query text, the generation processing prompt sentence, the generated text, and emotion information, as input and writes them into an interaction history database as structured records as output.

The server periodically reads accumulated history records as input and applies learning algorithms, such as gradient-based optimization on preference models or decision tree training on style selection outcomes, to derive updated parameters for sentence templates, style adjustment mappings, and motion selection policies as output.

The server deploys updated parameters to the runtime modules, adjusting future prompt construction, style control, and motion selection in subsequent interactions as output, thereby improving personalization, stability, and computational efficiency of the system.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

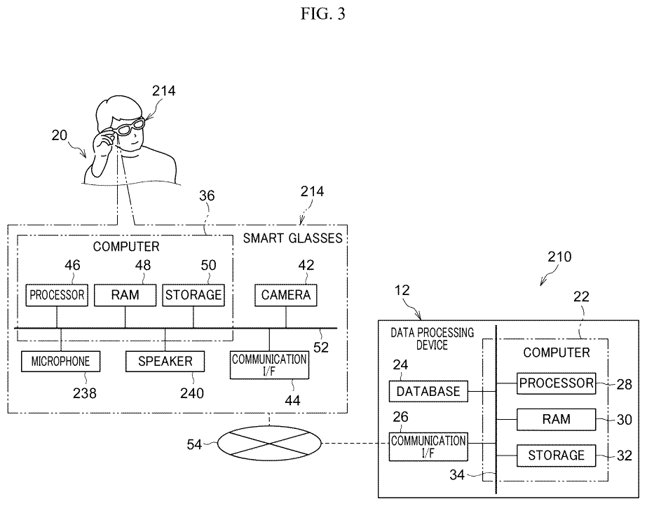

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

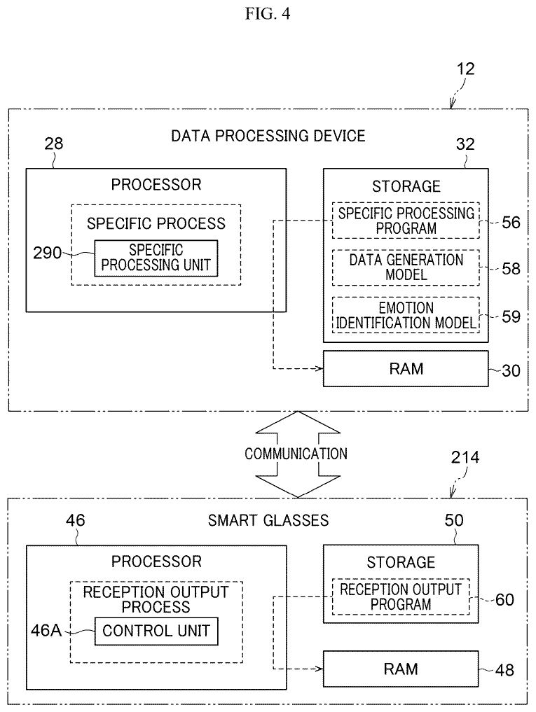

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

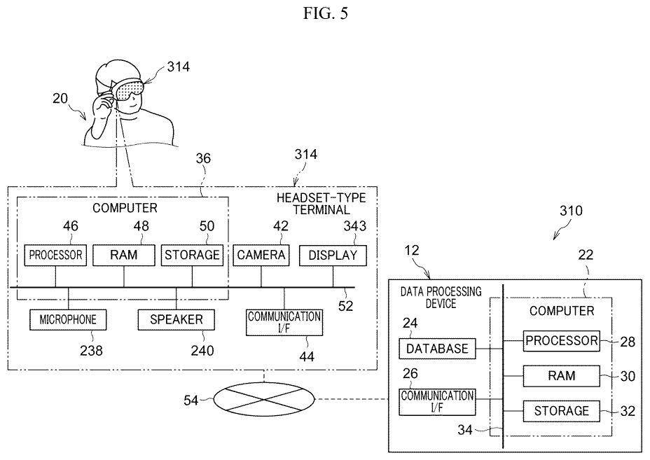

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

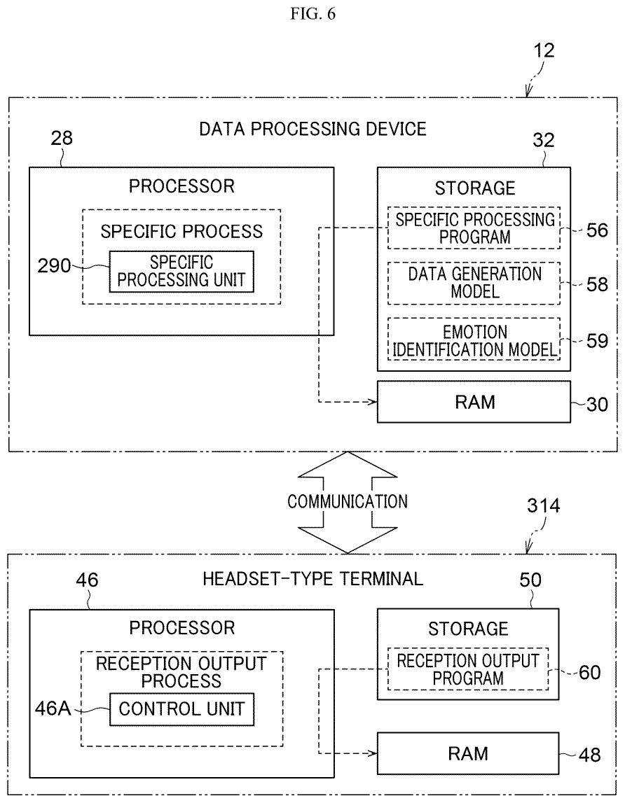

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

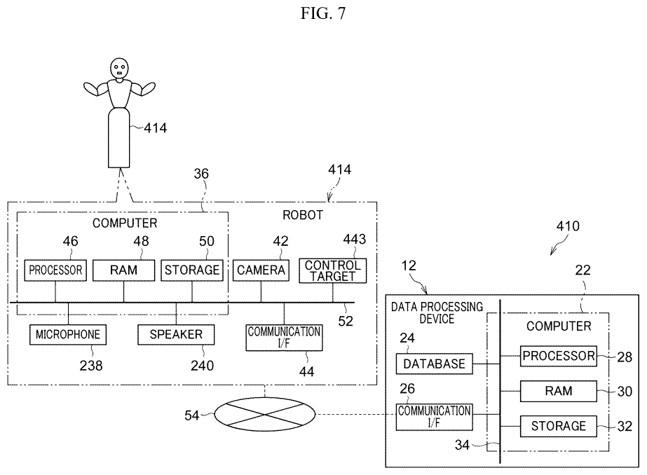

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

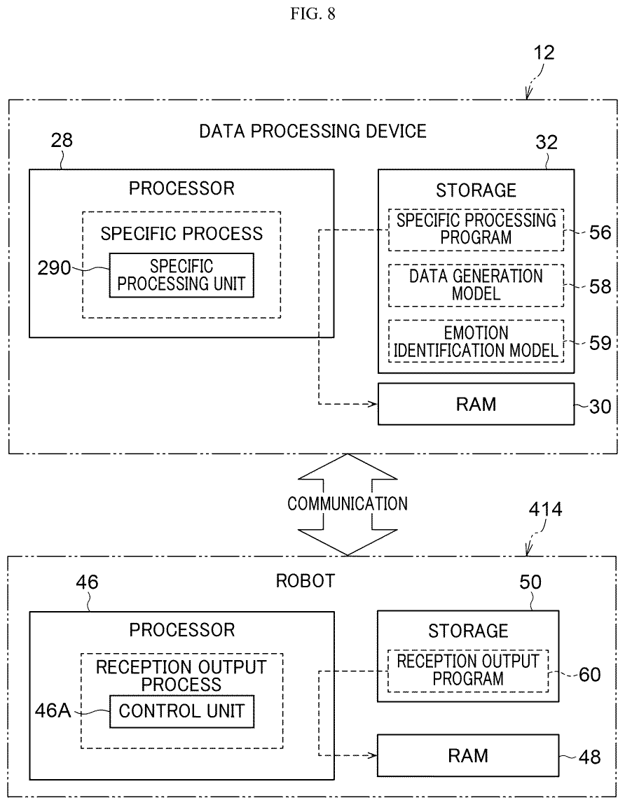

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

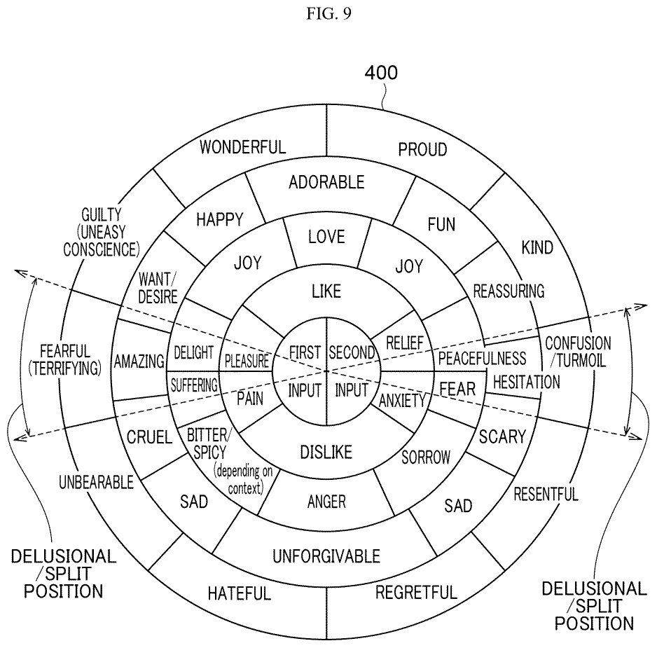

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

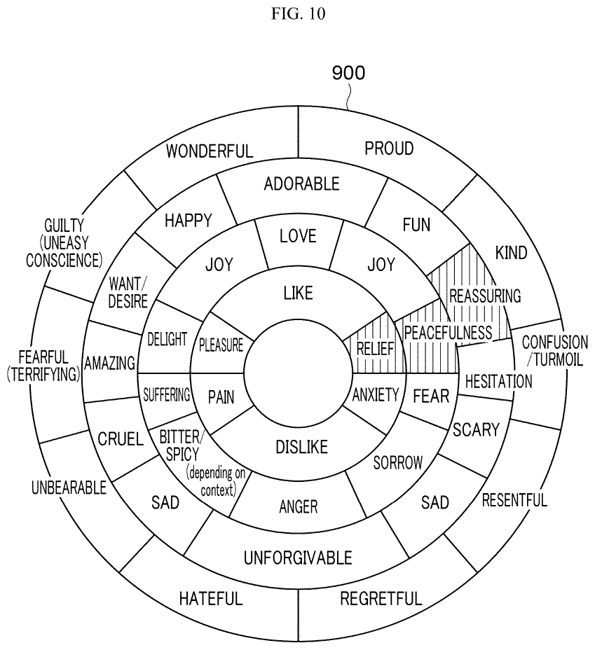

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
cause a user interface to be provided on an information processing terminal to allow a user to select and set a virtual display object and to store setting information relating to the virtual display object in a storage unit,
acquire, via an imaging mechanism mounted on the information processing terminal, image information of a real space or an image display surface in a time series, perform object recognition processing and situation recognition processing on the image information to generate situation information indicating a progress state of a competitive activity, and transmit the situation information to an external information processing apparatus via a communication path,
cause, in the external information processing apparatus, a motion information storage unit that stores motion information for a plurality of types of competitive activities to be searched based on the situation information and the setting information of the virtual display object, extract motion information corresponding to the situation information, and transmit the extracted motion information to the information processing terminal,
cause, in the information processing terminal, control data for posture and motion of the virtual display object to be generated based on the motion information, and cause the virtual display object to be superimposed and displayed on the image information by an augmented reality display process,
acquire a question input from the user as character information, generate a prompt sentence as descriptive text information including the character information, the situation information, and attribute information of the virtual display object, and transmit the prompt sentence to the external information processing apparatus for input to a generative AI model,
cause, in the external information processing apparatus, a response generation process by the generative AI model to be executed using the prompt sentence as input, and transmit response text information obtained as output to the information processing terminal,
cause, in the information processing terminal, the response text information to be displayed or output as sound as utterance content of the virtual display object and to perform question-and-answer presentation by giving mouth-shape motion and facial-expression motion corresponding to the response text information to the virtual display object,
estimate an emotional state of the user from voice information or image information of the user, and change an explanation style and a writing style of the response text by the virtual display object in accordance with the estimated emotional state, and
record past interaction history with the user and update user characteristic information and commentary policy information to be included in the prompt sentence based on the interaction history.

### (Supplementary 2)

The system according to supplementary 1,
wherein the processor is configured to
cause the motion information storage unit to store different motion information for each of a plurality of types of competitive activities and to select the motion information based on index information associated with each type of competitive activity and each competitive situation.

### (Supplementary 3)

The system according to supplementary 1,
wherein the processor is configured to
cause the external information processing apparatus to select a configuration template of the prompt sentence composed of a plurality of elements including a type of competitive activity, a match situation, numerical information, and an explanation target item, based on the situation information and question content of the user, and to dynamically generate the prompt sentence in accordance with the configuration template.

### Application Example 1

### (Supplementary 1)

A system comprising a processor,
wherein the processor is configured to
provide, on a user apparatus, a user interface including an information presenting unit and an information acquiring unit that allow a user to select and set attributes, speaker characteristics, and a language of a virtual entity,
acquire, from the user apparatus, setting information of the virtual entity selected by the user and image information obtained by an imaging device that captures a competitive activity scene or a video, and analyze the image information by using image-processing computational resources and trained recognition computational resources so as to recognize a competitive event based on the image information and obtain competitive context information corresponding to the recognized competitive event,
select and acquire, from an action storage unit including action information relating to a plurality of types of competitive activities and index information for specifying the action information, action information corresponding to the competitive context information, generate, based on the setting information of the virtual entity, the competitive context information, and the action information, a prompt sentence for instructing a generative information-processing resource to generate commentary information and response information,
input the prompt sentence to a generative AI model as the generative information-processing resource, and cause the generative AI model to generate natural language information
including the commentary information and the response information,
acquire voice input or character input from the user, analyze the input so as to incorporate the input into the prompt sentence, and estimate an emotional state of the user by using emotional-estimation computational resources,
adjust a style and an expression mode of the commentary information and the response information based on the estimated emotional state and the setting information of the virtual entity, and
synthesize and present, on the user apparatus, the natural language information on the image information by using display computational resources so as to overlay and display the commentary information and the response information on the image information.

### (Supplementary 2)

The system according to supplementary 1,
wherein the processor is configured to refer to the index information based on an analysis result of the image information and a selection by the user, and to select the action information corresponding to a relevant type of competitive activity from among the plurality of types of competitive activities in the action storage unit.

### (Supplementary 3)

The system according to supplementary 1,
wherein the processor is configured to record, in a history storage unit, past input history, viewing history, and virtual-entity selection history acquired from the user, and to use learning computational resources to update contents of the prompt sentence and generation conditions of the commentary information based on information recorded in the history storage unit, thereby sequentially adjusting contents of the commentary information and the response information generated by the generative AI model so as to adapt to a preference of the user.

### Example 2

### (Supplementary 1)

A system comprising a processor,
wherein the processor is configured to
provide a user interface including a display unit and an input unit, the user interface being configured to allow a user to set appearance attributes, voice attributes, and motion attributes of a preferred virtual character,
analyze image information or video information acquired by a portable information terminal, extract competition-type information and game-situation information corresponding to the image information or the video information, and generate display control information for superimposing the virtual character on the image information or the video information, manage a motion information storage unit that stores motion information relating to a plurality of types of competitions, search candidate motion information from the motion information storage unit on the basis of the competition-type information and the game-situation information, and acquire identification information and attribute information corresponding to the candidate motion information,
generate input information for a generative artificial intelligence model by using a prompt sentence including a natural-language query input by the user and the attribute information relating to the candidate motion information, extract or correct motion category information related to an intention of the prompt sentence by using the generative artificial intelligence model, evaluate the candidate motion information on the basis of output information obtained from the generative artificial intelligence model, and select at least one piece of optimal motion information from among the candidate motion information,
convert motion data corresponding to the optimal motion information into a format applicable to a skeletal structure of the virtual character, and transmit the motion data as motion control information for the virtual character to the portable information terminal,
supply the generative artificial intelligence model with input information including the prompt sentence and the attribute information relating to the optimal motion information, cause the generative artificial intelligence model to generate explanatory text information related to the optimal motion information, and transmit commentary control information for outputting the explanatory text information as commentary text information of the virtual character to the portable information terminal,
estimate an emotional state of the user on the basis of at least one of facial information, voice information, and operation information of the user, and generate commentary-style adjustment information for changing at least one of an expression style of the explanatory text information and a motion style of the virtual character in accordance with the emotional state, and
control the virtual character to perform question-and-answer processing and live commentary related to a sport while referring to the motion information storage unit, on the basis of the commentary-style adjustment information and the optimal motion information.

### (Supplementary 2)

The system according to supplementary 1,
wherein the processor is configured to cause the motion information storage unit to store motion information corresponding to a plurality of types of competitions, the motion information being provided with index information indicating at least one of competition type, motion type, difficulty classification, and role classification for each of the plurality of types of competitions, and to perform search control of the candidate motion information on the basis of the index information.

### (Supplementary 3)

The system according to supplementary 1,
wherein the processor is configured to record, as history information, past prompt sentences from the user, selected optimal motion information, and the emotional state, and to execute learning processing for updating at least one of the input information for the generative artificial intelligence model and the commentary-style adjustment information on the basis of the history information, thereby performing selection of motion information and live commentary adapted to a preference of the user.

### Application Example 2

### (Supplementary 1)

A system comprising a processor,
wherein the processor is configured to
provide a user interface that allows a user to set a preferred virtual display object, analyze image information acquired by a portable information processing apparatus in association with position and orientation information of the portable information processing apparatus, and generate motion information for the virtual display object so that the virtual display object is displayed in superposition on the image information, search a motion information storage unit in which motion information for the virtual display object is stored in an associatively retrievable manner on the basis of type information and situation information, and generate the motion information for the virtual display object by extracting motion information corresponding to the type information and the situation information associated with the image information,
convert voice information or character information acquired from the user into character string information by a recognition processing unit, extract intent information and target information from the character string information by a natural language analysis processing unit, and generate analysis result information by integrating the character string information with context information including the image information and the situation information
acquired from the motion information storage unit,
select a sentence template for constructing a prompt sentence for response generation on the basis of the analysis result information, user attribute information, and speaker attribute information of the virtual display object, and generate a generation processing prompt sentence by embedding the analysis result information into the sentence template, input the generation processing prompt sentence to a generative information processing model that executes natural language generation processing, cause the generative information processing model to generate response text information or commentary text information by inference processing, and acquire a generation result,
perform emotion estimation processing on the basis of facial expression information and voice feature information of the user, identify emotion information indicating an emotion type and an intensity, and generate style adjustment information for adjusting an expression style of the response text information or the commentary text information and a motion style of the virtual display object in accordance with the emotion information,
generate speech synthesis information and mouth shape information corresponding to the response text information or the commentary text information on the basis of the style adjustment information, and perform interactive commentary presentation on the portable information processing apparatus by outputting the speech synthesis information and the mouth shape information in association with the virtual display object so that the virtual display object is superposed on the image information, and
store, as history information, input information from the user, the generation processing prompt sentence, the generation result of the generative information processing model, and the emotion information, and perform learning processing to update the sentence template,
the style adjustment information, and selection conditions for the motion information on the basis of the history information.

### (Supplementary 2)

The system according to supplementary 1,
wherein the processor is configured to
control the motion information storage unit to store motion information indexed by at least one of a plurality of competition types or content types, event type information, emotion type information, and virtual display object attribute information, and select the motion information for the virtual display object from the motion information storage unit on the basis of at least one of the competition type or the content type, the event type information, the emotion information, and the virtual display object attribute information.

### (Supplementary 3)

The system according to supplementary 1,
wherein the processor is configured to
accumulate, for each user, interaction history including past input content of the user, the generation processing prompt sentence, the generation result of the generative information processing model, and reaction information of the user, estimate user preference information by statistical processing or machine learning processing on the interaction history, and change, for each user, at least one of the sentence template, generation conditions of the generation processing prompt sentence, and the style adjustment information on the basis of the estimated user preference information so as to optimize commentary presentation and question-and-answer processing for each user.

What is claimed is:

1. A system comprising:
circuitry configured to:
receive, via a communication interface coupled to a packet-switched network, situation information from a terminal device, the situation information being generated by the terminal device by performing object recognition and situation recognition on time-series image data acquired by an imaging mechanism of the terminal device, the situation information indicating a progress state of a competitive activity;
search, based on the situation information and setting information of a virtual display object selected by a user, a motion information storage unit storing motion information for a plurality of types of competitive activities, and extract motion information corresponding to the situation information;
transmit the extracted motion information to the terminal device via the communication interface for use in generating control data for posture and motion of the virtual display object for augmented-reality superimposition on the image data;
receive, from the terminal device via the communication interface, a prompt sentence including a question input by the user, the situation information, and attribute information of the virtual display object, and execute a response generation process using a generative AI model with the prompt sentence as input; and
recognize an emotion of the user based on data received from the terminal device, adjust a commentary style of the virtual display object in accordance with the recognized emotion, and transmit response text information to the terminal device via the communication interface for presentation as output of the virtual display object.

2. The system according to claim 1, wherein the circuitry is configured to manage the motion information storage unit as including motion data for a plurality of types of competitive activities and an index for selecting motion data corresponding to each type of competitive activity.

3. The system according to claim 2, wherein the circuitry is configured to extract motion information from the motion information storage unit by querying the index with a sport type and event type identified from the situation information.

4. The system according to claim 1, wherein the circuitry is configured to implement a learning algorithm by which the virtual display object learns through interaction with the user, record past behavior and preferences of the user in a storage device, and generate commentary content customized to preferences of the user based on the recorded past behavior and preferences.

5. The system according to claim 4, wherein the circuitry is configured to update the recorded preferences of the user based on feedback received from the terminal device after each interaction session, and use the updated preferences when generating prompt sentences for subsequent response generation.

6. The system according to claim 1, wherein the circuitry is configured to generate the prompt sentence for the generative AI model by incorporating the situation information, the attribute information of the virtual display object, user characteristic information, and commentary policy information derived from past interaction history.

7. The system according to claim 6, wherein the circuitry is configured to generate response text information including rule explanations, tactical commentary, or reactions to specific plays based on output of the generative AI model, and synchronize mouth-shape motion and facial-expression motion of the virtual display object with the response text information.

8. The system according to claim 1, wherein the circuitry is configured to recognize the emotion of the user by analyzing at least one of voice information, facial expression information, and linguistic features extracted from data received from the terminal device via the communication interface.

9. The system according to claim 8, wherein the circuitry is configured to adjust at least one of enthusiasm level, tone, and level of detail of commentary generated for the virtual display object based on the recognized emotion.

10. The system according to claim 1, wherein the circuitry is configured to receive user interface configuration data from the terminal device specifying a preferred virtual display object, and store the setting information associated with the preferred virtual display object in a storage device.

11. The system according to claim 10, wherein the circuitry is configured to associate the setting information of the virtual display object with a user identifier, and retrieve the setting information using the user identifier when generating motion information or commentary content for the user.

12. The system according to claim 1, wherein the circuitry is configured to transmit, to the terminal device, augmented-reality rendering data including the motion information and the response text information synchronized with a timing derived from the situation information.

13. The system according to claim 1, wherein the circuitry is configured to receive audio data from the terminal device in addition to the situation information, perform audio analysis on the received audio data to supplement the situation information with acoustic context, and incorporate the acoustic context into the prompt sentence.

14. The system according to claim 1, wherein the circuitry is configured to store records of questions asked by the user and responses generated by the generative AI model in a storage device, and use the stored records to personalize subsequent prompt sentences generated for the user.

15. The system according to claim 1, wherein the circuitry is configured to generate a commentary prompt sentence incorporating at least the situation information, a sport type, and a current score or game state, and input the commentary prompt sentence to the generative AI model to generate proactive commentary for the virtual display object.

16. The system according to claim 1, wherein the circuitry is configured to receive, from the terminal device, a request to explain a rule or tactic related to the current competitive activity, generate a prompt sentence incorporating the request and the situation information, and input the prompt sentence to the generative AI model to generate an explanation response.

17. The system according to claim 16, wherein the circuitry is configured to generate the explanation response as text information, convert the text information into voice data using a speech synthesis unit, and transmit the voice data to the terminal device for playback as audio output of the virtual display object.

18. A system comprising:
circuitry configured to:
receive, via a communication interface coupled to a packet-switched network, situation information from a terminal device, the situation information indicating a progress state of a competitive activity, and setting information of a virtual display object selected by a user;
search a motion information storage unit based on the situation information and extract motion information corresponding to the competitive activity, and transmit the extracted motion information to the terminal device via the communication interface;
receive a prompt sentence from the terminal device incorporating a question from the user and the situation information, execute a response generation process using a generative AI model with the prompt sentence as input, and recognize an emotion of the user based on data received from the terminal device; and
adjust a commentary style of the virtual display object based on the recognized emotion and transmit response text information to the terminal device via the communication interface for synchronized presentation with motion of the virtual display object.

19. The system according to claim 18, wherein the circuitry is configured to implement a learning algorithm that records past behavior and preferences of the user in a storage device, and generate commentary content for the virtual display object customized to the preferences of the user based on the recorded past behavior and preferences.

20. A method comprising:
receiving, via a communication interface coupled to a packet-switched network, situation information from a terminal device, the situation information being generated by the terminal device by performing object recognition and situation recognition on time-series image data, the situation information indicating a progress state of a competitive activity;
searching, based on the situation information and setting information of a virtual display object selected by a user, a motion information storage unit storing motion information for a plurality of types of competitive activities, and extracting motion information corresponding to the situation information;
receiving, from the terminal device via the communication interface, a prompt sentence including a question input by the user and the situation information, and executing a response generation process using a generative AI model with the prompt sentence as input; and
recognizing an emotion of the user based on data received from the terminal device, adjusting a commentary style of the virtual display object in accordance with the recognized emotion, and transmitting response text information to the terminal device via the communication interface.
